(19) United States
(12) Patent Application Publication
(10) Pub. No.: US 2015/0145991 A1
(43) Pub. Date: May 28, 2015

(54) SYSTEM AND METHOD FOR SHARED SURVEILLANCE

(71) Applicant: Vose Technical Systems, Inc., Tacoma, WA (US)

(72) Inventors: Jeffrey W. RUSSELL, Austin, TX (US); Gregory A. VOSE, Tacoma, WA (US)

(21) Appl. No.: 14/478,633

(22) Filed: Sep. 5, 2014

Related U.S. Application Data
(60) Provisional application No. 61/907,795, filed on Nov. 22, 2013.

(51) Int. Cl. H04N 7/18

(52) U.S. Cl. CPC H04N 7/181
USPC 348/143

(57) ABSTRACT

A common surveillance system allows multiple users to share and communicate surveillance data with each other as well as with one or more agencies, such as law enforcement, hospitals, and/or emergency services. A geo-reference database stores image data from imaging devices. A computer-implemented user interface accesses the geo-reference database to present stored image data on a display device. The user interface generates a status-board display, accessible to a specific client computer, showing images relating to a time and/or location of a display view imaged from the imaging devices. A common-operating platform shows images with a time and/or location associated with each image and is globally accessible to multiple client computers via one or more data communication networks. Based on a user input, images may be shared real-time via a bridge between the status-board display and the common-operating platform.

### CROSS-REFERENCE TO RELATED APPLICATIONS

This application claims priority to U.S. Application No. 61/907,795, filed Nov. 22, 2013, the entire contents of which are incorporated herein by reference.

### BACKGROUND AND SUMMARY

Surveillance means to “watch over” and includes the monitoring of the behavior, activities, or other changing information, usually of people for the purpose of influencing, managing, directing, or protecting people and/or resources. Surveillance is useful to maintain control, recognize and monitor threats, and prevent/investigate unwanted activity. Whether the surveillance is to enforce traffic laws, protect property, or even just see what is going on the front yard of someone's own home, surveillance can greatly strengthen a home, a business, a community, a town, and/or a nation.

Conventional surveillance systems typically involve some type of image and/or audio recording device communicating with a system to store the recorded data and to let a user simultaneously view the image/audio as it is being recorded. Distributed image/audio recording devices may also communicate with a centralized hub. Although information can be gathered from multiple surveillance devices, systems lack an ability for this gathered surveillance information to be communicated between multiple users. That is, many surveillance systems only allow the user to see their own personal surveillance environment and do not allow for a common picture showing surveillance data including images shared between multiple users.

Conventional surveillance systems also do not have an efficient way to communicate gathered surveillance information to federal, state, and local agencies, such as local law enforcement. Communication problems stem from a lack of widely-distributed collection systems and mechanisms to rapidly organize incoming image and narrative data, evaluate the data, and communicate to interested parties. It would be desirable for a surveillance system to be able to rapidly communicate images and narrative information to decision-makers and other interested parties so that safety is assured and proper resources are allocated.

The technology of the present application addresses and solves these and other problems, in example implementations, by providing a common surveillance system (e.g., a common operating platform) where multiple users can share and communicate surveillance data to each other. This common surveillance system also allows users to communicate the surveillance data to one or more agencies, such as local law enforcement, hospitals, private security, and/or emergency services.

Example system embodiments include one or more memories and one or more processors that generate a common operating platform of a surveillance system for display by remote client devices. The system generates, for display on a display device, a client-specific status board having a customized surveillance picture including multiple display views from multiple surveillance sources. Each of the multiple display views is associated with a time and place. The system also generates, for display on the display device, the common operating platform having a map with multiple display views from multiple surveillance sources that are provided by the client devices, and communicates, in response to operation input, one or more display views in real-time between the client-specific status board and the common operating platform. It should be appreciated that “real-time” could refer to instantaneous action and/or action immediately taken but delayed only by latency of the system.

Example system embodiments may also include one or more geo-reference databases that store image data from one or more imaging devices and a computer-implemented user interface to access the one or more geo-reference databases so that at least some of the stored image data may be presented via the user interface on a display device. The computer-implemented user interface is configured to generate a status-board display showing one or more images relating to a time and/or location of a display view imaged from the one or more imaging devices. The status-board display is accessible to a specific client computer. The common operating platform shows one or more images having a time and/or location associated with each image and is preferably (though not necessarily) globally accessible to multiple client computers via one or more data communication networks. Based on user input, one or more images may be designated to be shared real-time via a bridge between the status-board display and the common-operating platform. In an example implementation, the one or more images may be represented in a first manner on the status-board display and represented in a second manner in the common-operating platform.

The present technology further includes example methods implemented using an information processing apparatus having one or more processors and that generate a common operating platform of a surveillance system for display by remote client devices. A client-specific status board having a customized surveillance picture including multiple display views from multiple surveillance sources is displayed. Each of the multiple display views is associated with a time and place. The common operating platform is also displayed and includes a map having multiple display views from multiple surveillance sources that are provided by the client devices. In response to operation input, one or more display views are communicated in real-time between the client-specific status board and the common operating platform.

In a non-limiting, example implementation a user can access the common operating platform based on display views and provide input data to the common operating platform.

In another non-limiting, example implementation the system can set a status indicator for a view of the one or more display views shared between the common-surveillance system and the client-specific status board and display the status indicator along with the shared view in the common-surveillance system and/or the client-specific status board.

In yet another non-limiting, example implementation the system can associate a description for a view of the one or more display views shared between the common-surveillance system and the client-specific status board and display the description along with the shared view in the common-surveillance system and/or the client-specific status board.

In another non-limiting, example implementation the one or more views originate from one or more mobile imaging devices that are configured to record an event indicating at least a time and a location of the event.

In yet another non-limiting, example implementation the system can image one or more payment cards using the one or more surveillance sources, generate data related to the one or more payment cards, and store the generated data and the imaged one or more payment cards in a database.

In another non-limiting, example implementation the system can submit at least one image generated from the one or more surveillance sources to an emergency facility, the at least one image encoded to provide information relevant to an event requiring services of the emergency facility.

In yet a further non-limiting, example implementation the encoded information comprises at least one of a time of the event, a date of the event, a location of the event, an altitude of the surveillance source, a direction being viewed by the surveillance source, and/or a type of surveillance source.

In another non-limiting, example implementation the one or more display views from the one or more surveillance sources represent a single location.

In a further non-limiting, example implementation the one or more images are represented in the first manner by showing thumbnail views of the one or more images.

In yet another non-limiting, example implementation the one or more images are represented in the second manner by showing icons in a map based view corresponding to the one or more images.

### BRIEF DESCRIPTION OF THE DRAWINGS

FIG. 1 is a block diagram of an example surveillance system;

FIG. 2 is a block diagram of the example surveillance system communicating with multiple surveillance sources;

FIG. 3a is a diagram showing a high level diagram of the example surveillance system;

FIG. 3b is a diagram showing a back-end process for communicating and sharing surveillance image data in the example surveillance system;

FIG. 4 is a diagram showing a display of a status board in the example surveillance system;

FIG. 5 is a diagram showing a detail level of a communication message in the example surveillance system;

FIG. 6 shows a diagram of a display for a responder assist portion of the example surveillance system;

FIG. 7 shows a diagram of a display for the responder assist with a surveillance image being identified on a surveillance map in the example surveillance system;

FIG. 8 is a diagram of a display for the responder assist with one or more filters expanded in the options in the example surveillance system;

FIG. 9 is a diagram of a display for the responder assist with one or more agencies identified in the surveillance map of the example surveillance system;

FIG. 10 is a diagram of a display for the responder assist showing a specific image from a surveillance device in the example surveillance system;

FIG. 11 shows a diagram of a mobile collection network in the example surveillance system;

FIGS. 12(a) and 12(b) show a diagram of a tablet credit/debit card security system in the example surveillance system;

FIGS. 13(a) and 13(b) show a diagram of the tablet credit/debit card security system communicating with the example surveillance system and a point of sale device;

FIG. 14 is a flowchart showing a basic flow of processes for the example surveillance system;

FIG. 15 is a flowchart showing a more detailed flow of processes for selecting and displaying surveillance data for both the Status Board display mode and the COP display mode;

FIGS. 16a-g show a diagram of an example application architecture for maintaining and creating the methods and systems described above;

FIGS. 17a-b illustrate a non-limiting example application that can employ the techniques of the system described in this specification; and

FIGS. 18a-b show amber alert features that can be displayed using both the normal user interface as well as the interface on the mobile application.

### DETAILED DESCRIPTION

In the following description, for purposes of explanation and non-limitation, specific details are set forth, such as particular nodes, functional entities, techniques, protocols, etc. in order to provide an understanding of the described technology. It will be apparent to one skilled in the art that other embodiments may be practiced apart from the specific details described below. In other instances, detailed descriptions of well-known methods, devices, techniques, etc. are omitted so as not to obscure the description with unnecessary detail. Individual function blocks are shown in the figures. Those skilled in the art will appreciate that the functions of those blocks may be implemented using individual hardware circuits, using software programs and data in conjunction with a suitably programmed microprocessor or general purpose computer, using applications specific integrated circuitry (ASIC), and/or using one or more digital signal processors (DSPs). The software program instructions and data may be stored on non-transitory computer-readable storage medium and when the instructions are executed by a computer or other suitable processor control, the computer or processor performs the functions. Although databases may be depicted as tables below, other formats (including relational databases, object-based models and/or distributed databases) may be used to store and manipulate data.

Although process steps, algorithms or the like may be described or claimed in a particular sequential order, such processes may be configured to work in different orders. In other words, any sequence or order of steps that may be explicitly described or claimed does not necessarily indicate a requirement that the steps be performed in that order. The steps of processes described herein may be performed in any order possible. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention(s), and does not imply that the illustrated process is preferred. A description of a process is a description of an apparatus for performing the process. The apparatus that performs the process may include, e.g., a processor and those input devices and output devices that are appropriate to perform the process.

Various forms of computer readable media may be involved in carrying data (e.g., sequences of instructions) to a processor. For example, data may be (i) delivered from RAM to a processor; (ii) carried over any type of transmission medium (e.g., wire, wireless, optical, etc.); (iii) formatted and/or transmitted according to numerous formats, standards or protocols, such as Ethernet (or IEEE 802.3), SAP, ATP, Bluetooth, and TCP/IP, TDMA, CDMA, 3G, etc.; and/or (iv) encrypted to ensure privacy or prevent fraud in any of a variety of ways well known in the art.

An example embodiment of the surveillance system (SS) collects image data from a variety of sources and provides near real-time sharing of selected images between different users of the system. The system may be implemented using one or more computing devices (e.g., one or more servers) and/or using a distributed computing system (e.g., “cloud” computing). As a non-limiting example, a “back end” of the surveillance system may be implemented using a collection of servers, where the servers provide access to the user interfaces and services sometimes referred to as the “front end” described in detail below.

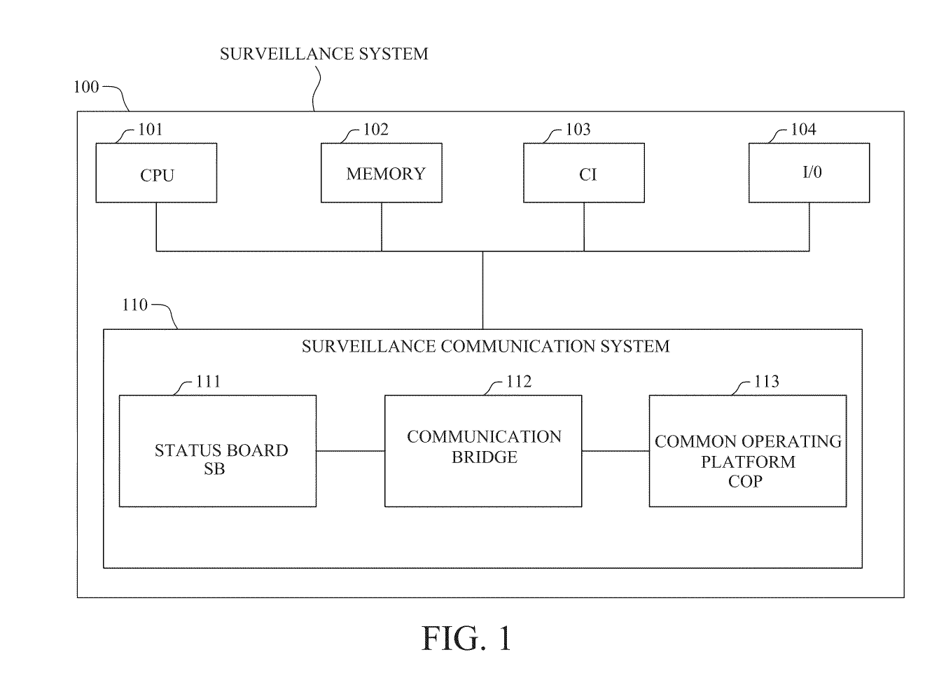

FIG. 1 is a block diagram of an example surveillance system 100 which includes a CPU 101, memory 102, communication interface 103, and an input/output interface 104. The system 100 also comprises a surveillance communication system 110 having a Status Board 111, a communication bridge 112, and a Common Operating Platform 113. The surveillance communication system 110 is configured with a user interface that allows one or more users to personalize and share image and/or audio data retrieved from surveillance sources. As explained in further detail below, the surveillance system 100 communicates with multiple surveillance devices and multiple users and/or agencies.

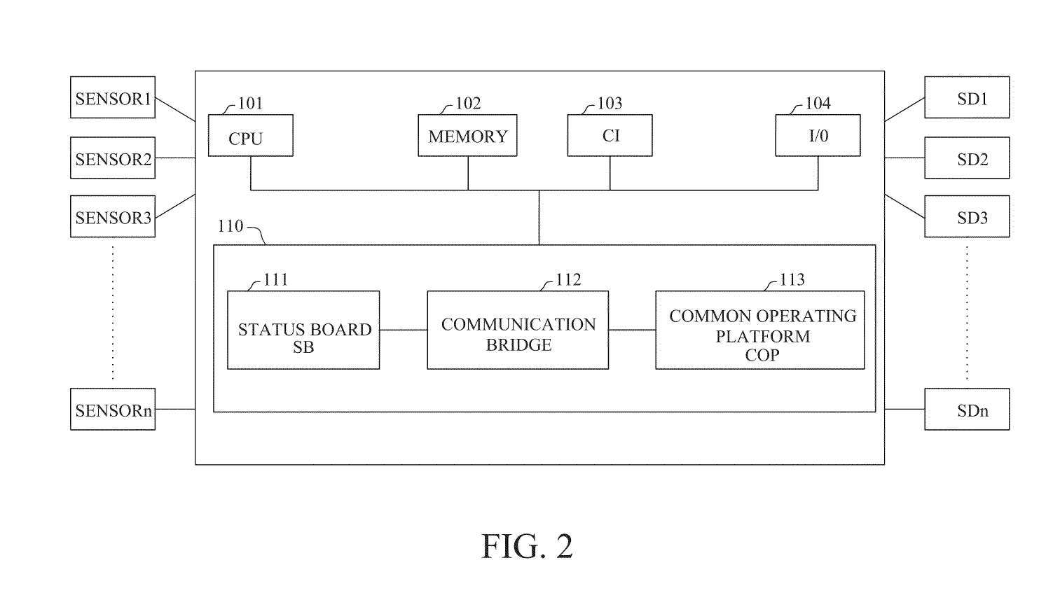

FIG. 2 is a block diagram of the example surveillance system communicating with multiple surveillance sources. In the example shown in FIG. 2, the surveillance system 100 can receive image and/or audio data from one or more sensors 1-n. The sensors 1-n may be cameras set up at various locations, such as surveillance cameras at a facility or a camera watching traffic at an intersection, for example. The images may also be received from one or more user communication devices such as smart phones, PDAs, laptops, etc. Of course, the system is not limited to receiving data from security cameras and user devices and may receive image data from a variety of sources.

The image and/or audio data collected by the surveillance system 100 may be personalized and shared between users of the system 100. The image and/or audio data may be conveyed to one or more surveillance destinations (SD) SD1-SDn. As described in further detail below, the one or more surveillance destinations SD1-SDn can use the image and/or audio data in providing services to the party that provides the image and/or audio data.

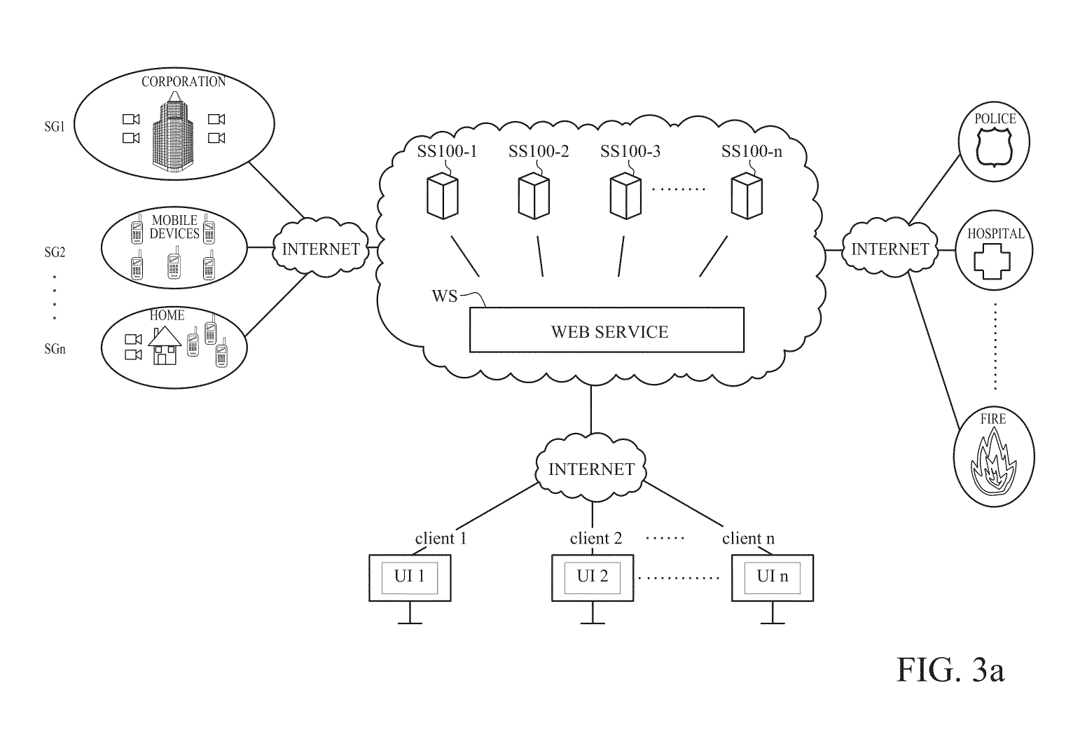

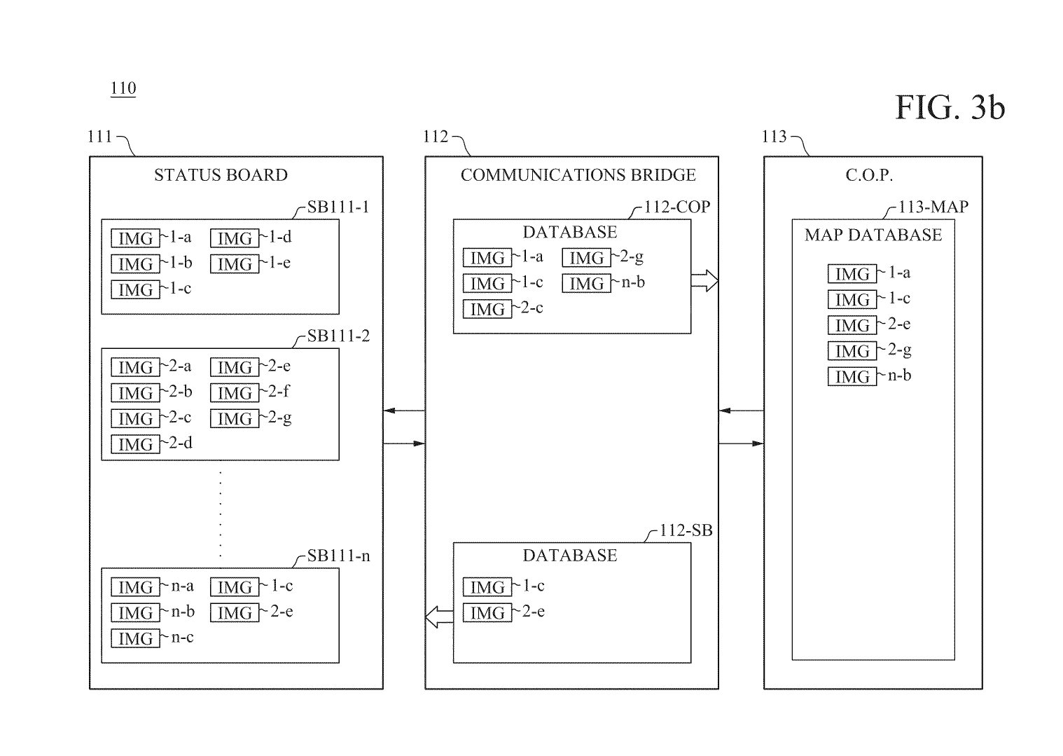

FIG. 3a is a high level diagram in which the example surveillance system is implemented using distributed systems SS100-1-SS100-n. These distributed systems may be stand-alone servers or part of a distributed computing system, such as a “cloud” computing system. The distributed systems SS100-1-SS100-n are also capable of interacting with a web service WS which can provide additional services that are used in combination with the services provided by the example surveillance system. For example, the distributed systems SS100-1-SS100-n can provide surveillance image data to the web service (WS) which can incorporate the surveillance image data with an electronic mapping service provided by the web service WS. This combined image data can then be accessed by and/or transmitted to one or more clients 1-n, where the user interfaces (UI) UI1-n for each device will respectively show the map data provided by web service WS overlaid with the surveillance image data provided by the systems SS100-1-SS100-n.

The systems SS100-1-SS100-n are also in communication with multiple surveillance groups (SG) SG1-n. Each surveillance group represents in this example a common entity, such as a family home or a corporation, or a group of surveillance sources, such as a collection of images from different mobile devices in a common location (e.g., a sporting event). Each camera in each respective group corresponds to a sensor that images and transmits the image data to the example surveillance system. For example, in surveillance group SG1, the corporation uses multiple security cameras to monitor the physical premises of the business. Example surveillance group SG2 represents a collection of mobile devices at a sporting event where the images from each device are captured and/or transmitted to the example surveillance system. Likewise, example surveillance group SG3 represents a surveillance environment at a single family home where the system gathers information from surveillance cameras as well as images from one or more mobile devices.

The systems SS100-1-SS100-n use this image data to populate one of more user Status Boards 111 and the Common Operating Platform 113. The systems SS100-1-SS100-n may also relay surveillance image data to one or more surveillance destinations (SD) SD1-n, such as those shown in FIG. 2, for example. In the example shown in FIG. 3a, the example surveillance destinations SD1-n include municipal services such as police stations, fire stations, and/or hospitals, but they are not limited to these examples and could encompass any variety of entities that could use the image data provided from the example surveillance system. For example, surveillance destination SD2 may represent one or more emergency facilities (e.g., hospitals), where the image conveyed to the surveillance destination SD2 informs the hospital that a person is injured and provides the location of the person as well as the time of the injury. This information may then be used by hospital personnel to deploy an ambulance to help the individual. Of course, the destination SD2 is not limited to a hospital and could be any type of service such as a police station, fire station, homeland security, or non-emergency type services.

FIG. 3b is a diagram showing a back-end process for communicating and sharing surveillance image data in the example surveillance communication system 110. The Status Board 111 is in bi-directional communication with the Communications Bridge 112, and the Communications Bridge 112 is in bi-directional communication with the COP 113. Status Board 111 comprises a plurality of individual status boards (SB) SB111-1-SB111-N. Each of the status boards SB111-1-SB111-N comprises image data (IMG) that corresponds to the image data captured from one or more respective sensors. For example, Status Board SB111-1 in this example has five images IMG 1 a-e, Status Board SB111-2 has seven images IMG 2 a-g, and Status Board SB111-N has five images IMG N a-e.

The examples shown in FIG. 3b depict operation of the surveillance system “back end” based, in part, on inputs provided from a “front end” via the user interfaces. For example, a user can access the Status Board SB111-1 using a user interface and select one or more images to be designated as shared on the COP 113. These images are communicated to the COP 113 using the Communications Bridge 112. In the example shown in the figure, images IMG 1-a, -c; IMG 2-e, -g; and IMG N-b are designated to be shared in the COP 113 and are queued for sharing by linking the image data in a database 112-COP of the communications bridge. These images are used, for example, in a map database 113-MAP of the COP 113, where the map database 113-MAP is used to populate a graphical display of a map containing images and/or links to the image data IMG 1-a, -c; IMG 2-e, -g; and IMG N-b.

Just as a user can designate images to be shared from the Status Board 111 to the COP 113, a user can also designate images for display in the user's own Status Board 111. In the example shown in FIG. 3b, images IMG 1-c; IMG 2-e are designated for sharing on an individual Status Board SB111-N by linking the images in a Status Board database 112-SB of the Communications Bridge 112. These images may then be accessed and/or displayed on a user interface with access to Status Board SB 111-N. The details of these user interfaces are explained further in conjunction with the figures described below.

The “front end” of the surveillance system 100 provides a user interface comprising two main components: Status Board 111 and Common Operating Platform 113. As a non-limiting example, the Status Board 111 represents a user interface that allows a user to create and maintain their own personal surveillance system comprising one or more images taken from a variety of surveillance sources (e.g., cameras). The Status Board 111 allows control of information and/or images by accepting users and assigning levels of responsibility and access; assigning email accounts to devices; creating geo-referenced sectors and subsectors; sending email alerts and acting as a gateway to the Common Operating Platform. The Status Board 111 has a message bar that displays changes and other necessary information. It should be appreciated that cameras (i.e., surveillance devices) can be controlled (activated/deactivated/turned-on or off) from the Status Board 111 as well as the Common Operating Platform 113.

The Common Operating Platform 113 represents another user interface that allows a user to both share selected images (i.e., from the Status Board 111) as well as view images that are shared by other users. The Common Operating Platform (COP) 113 receives images and displays the location of the device that captured the image (e.g., on a map). In addition to this data, the COP can create overlays of relevant data for incidents, events, and infrastructure, serving as a repository for customizable icons for shared images.

The COP preferably forms part of a database (which may be a distributed database) that records events and stores them and so that the events can be replayed over a designated time period. The COP, in an example embodiment, is also capable of storing and displaying Key Hole Markup (KML) language data files and serving as a gateway to other information through KML files and Internet access. The COP also displays live feed Closed Circuit Television feeds; radar images; RSS feeds; web pages and the movement/position of GPS or transponder equipped vehicles and devices. Thus, the Common Operating Platform technology globally shares and permits viewing of images obtained from one or more surveillance devices.

The surveillance system may also include the communications bridge 112 between the status boards 111 and the COP 113 so that both have access to analyze available surveillance information for content, time, place, and/or other data. This bridging capability also allows the user to conduct trend analysis based upon the stored data in the system. The use of user-specific Status Boards (or surveillance system) that communicate information to/from the COP (or common surveillance system) permits many surveillance images and information to be conveyed to a global system where many different users and/or services benefit from the shared surveillance data.

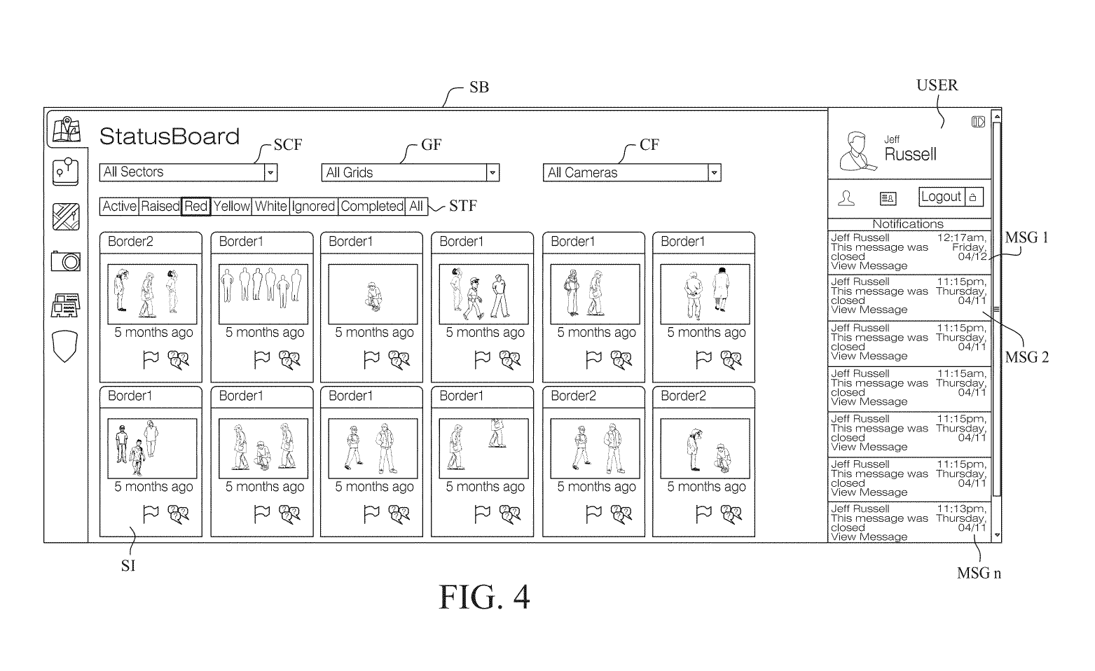

FIG. 4 is a diagram showing an example display of a surveillance system status board. The status board is a user-customizable interface that shows one or more surveillance images (SI) from one or more surveillance sources (SS) SS1-SSn (not shown in FIG. 4). The user can select one or more of the surveillance images SI to be shared in the common surveillance system referred to in the above as COP 113 where multiple users can access the surveillance image SI. The user can also annotate messages MSG1-n for each surveillance image SI to be passed on to the COP 113. For example, the user can select an image SI and then provide a message MSG1 associated with one or more events, objects, and/or any other information conveyed in the image.

Both the image SI and the information provided in the message MSG1 can then be conveyed to the COP 113 to be shared with other users. This means that a user can convey what is on the user's Status Board 111 to other users in a matter of seconds. The surveillance system 111 also provides the user with several options including section filters (SCF), grid filters (GF), camera filters (CF), and status filters (STF). Sections are designated areas that are normally large and well-defined. Grids are smaller defined areas within sections. These filters can filter the selected images SI based on the sector, grid, camera, and/or status of the image. In the example shown in FIG. 4, the images SI with status “Red” (e.g., displayed with a red color) are filtered so that the system 111 only shows the images that with the Red status. The system 111 may establish threat levels and communicate threats and other relevant information rapidly to large numbers of system users, e.g., via email, SMS texts, voice calls, and/or any other suitable communication method or technology.

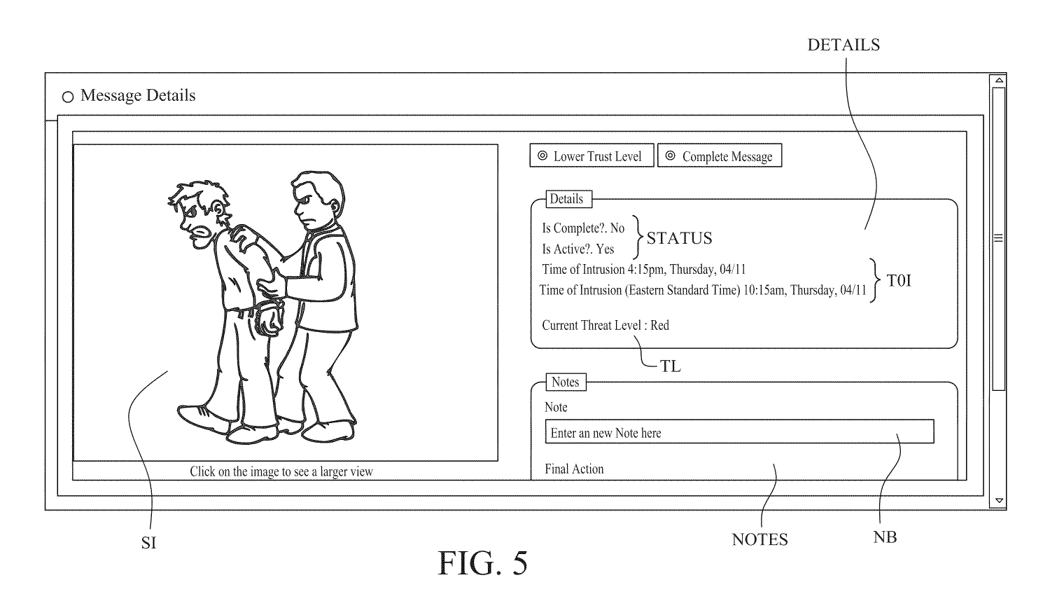

FIG. 5 is a diagram showing an example communication “message details” in the surveillance system. In this example, the user created a messages MSG that provides information regarding the content of the surveillance image SI shown. The example message detail screen also shows a “details” portion and a “notes” portion to the right of the image SI. The details portion can contain, for example, a status of the message (e.g., active, complete, etc.) as well as a time of event (e.g., a time of intrusion (TOI)) and a threat level (TL). The user can also enter notes in a notes box (NB). In the example shown in FIG. 5, the message detail conveys a threat occurring at one of the surveillance sources. These aspects of the message details in this example are conveyed to the COP 113 so that one or more law enforcement agencies may act on the threat.

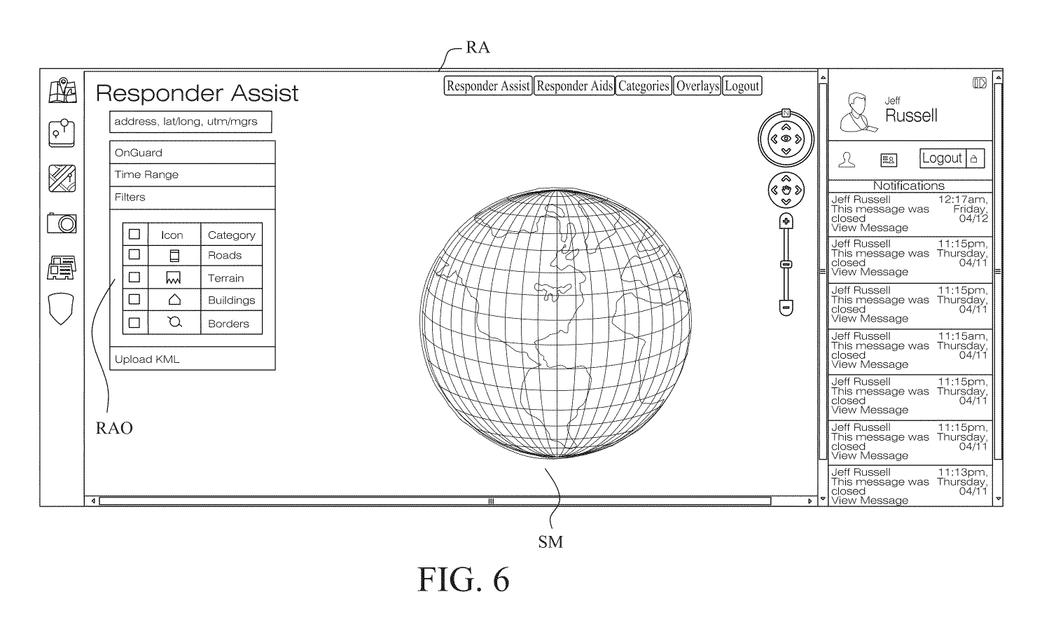

FIG. 6 shows an example display for a Responder Assist screen in a COP 113 display. The example image shown in the example of FIG. 6 shows a surveillance map (SM) which shows the location(s) of the source(s) of the surveillance images (SI). The Responder Assist screen can also provide multiple Responder Assist Options (RAOs) which can be used to customize the image shown on the Responder Assist screen.

The surveillance map SM can use a computer-provided host that provides a virtual globe and/or map. In the COP 113, each data record in the COP 113 database may be represented as an icon on a Keyhole Markup Language (KML) file generated map. The COP 113 may maintain many layers (e.g., thousands of layers) of data as well as many (e.g., thousands of) documents and images. The COP 113 is also equipped with an Intrusion Detection System (IDS), and the data residing on the COP 113 can be encrypted. As such, certain capabilities will accompany the COP 113 if the system is migrated to another server and certain protocols ensure that all data is stored appropriately according to the requirements of the user. Certain protocols can also ensure that no data (e.g., pictures, video, tabular, test, etc.) is deleted unless the action is acknowledged by supervisory personnel and even if data is deleted, there will be a metadata record of any deletions or other data-altering actions.

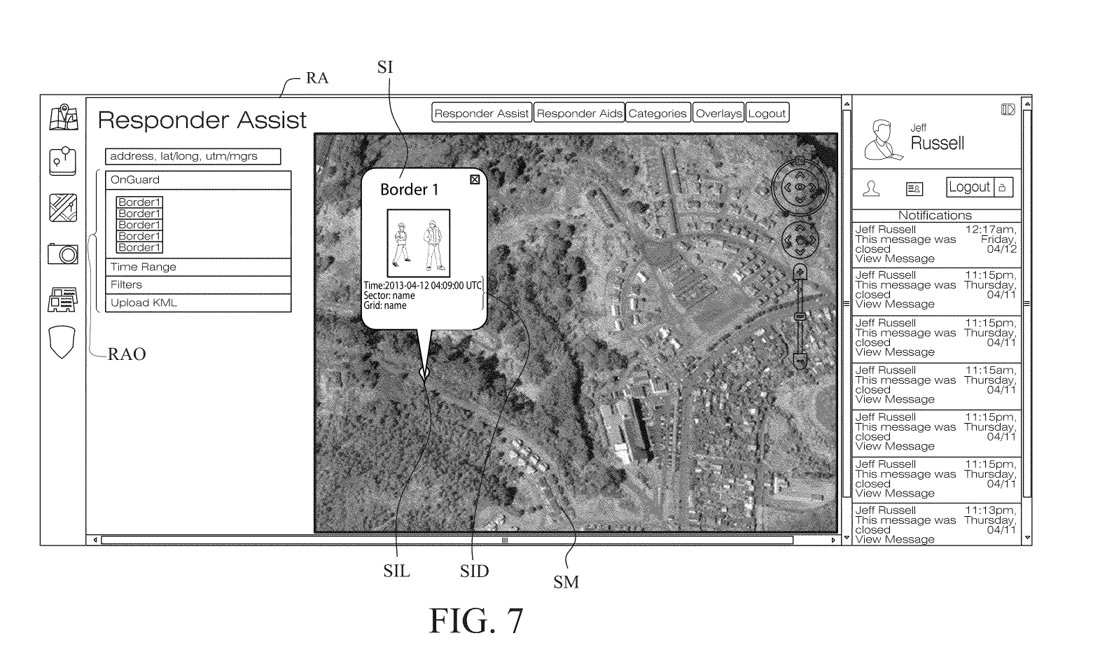

FIG. 7 shows an example Responder Assist (RA) display screen shot with a surveillance image (SI) being identified on a surveillance map (SM). The Responder Assist screen shows the surveillance map with an identified surveillance image (SI). The surveillance image SI has an associated surveillance image location (SIL) as well as surveillance image identification information (SID). The Responder Assist screen can display one or more surveillance images SI that are shared from a Status Board 111 of one or more users in order to obtain information about the various surveillance images, such as details surrounding the image as well as the location where the image was taken. Thus, the COP 113 can show multiple surveillance images SI where each image can have a corresponding ID and location providing a user with easy reference information for each image.

It should be appreciated that while the system 100 is designed to rapidly share information/data across a wide number of users, access can be tightly controlled and information access can be assigned based for example upon location and/or a designated information access level. As one example, at the national level, certain users may have total access to the COP's information, while at the district level, border guards may only be able to access information in their immediate vicinity. In the example shown in FIG. 7, an image from a sensor (Border1) is elevated by a monitor to “Red” status. The system 100 can move a copy of the image from control software to the sensors recording at the location identified in the COP 113. As this occurs, a “chat/message” bar on the right side of the screen records the action and sends a network-wide notification that an event occurred that warrants attention. Security personnel may access the images and locations from smartphones, tablets, laptops, etc., and the monitor also has the option of immediately sending the image by email to designated personnel so that they may view the image before accessing the COP 113.

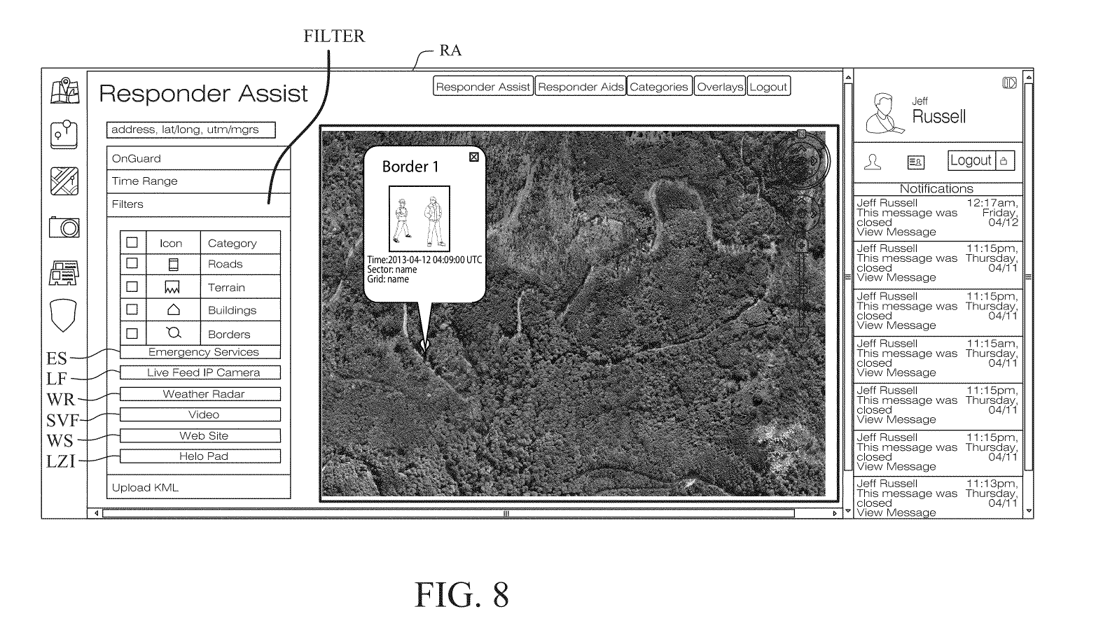

FIG. 8 is a diagram of an example Responder Assist display with one or more filters expanded in the options on the left side of the screen shot. In this example shown in FIG. 8, the Responder Assist screen shows an expanded portion for “Filters” including filtering icons by particular categories, such as roads, terrain, buildings, and/or borders. The Filter portion can also include filtering icons/images shown in the surveillance map SM based on the emergency services (ES) for a particular area shown in the surveillance map SM, a live feed of IP cameras (LF), and weather radar (WR) for a particular area. The filtering portion can further include filtering icons/images based on surveillance video (SVF) for the area, web-site (WS) links indicative of information shown in the area displayed in map SM, and/or landing zone information (LZI) which provides information related to areas to land aircraft, such as helipads and/or landing strips.

Security personnel can use the Responder Assist by adding additional information to the COP 113 as desired, e.g., the situation evolves. In the example shown in FIG. 8, the green “filter” bars on the left of the screen shot allow personnel to rapidly load map and other data for an area. As explained above, the filters may be set to display area emergency services, live IP camera (CCTV) feeds, weather radar, stored video files about the area, informative websites about the area and/or helipad/lading zone information. Information icons can appear on the map that display specific to general locations of activities and infrastructure along with information as to the nature of the activity.

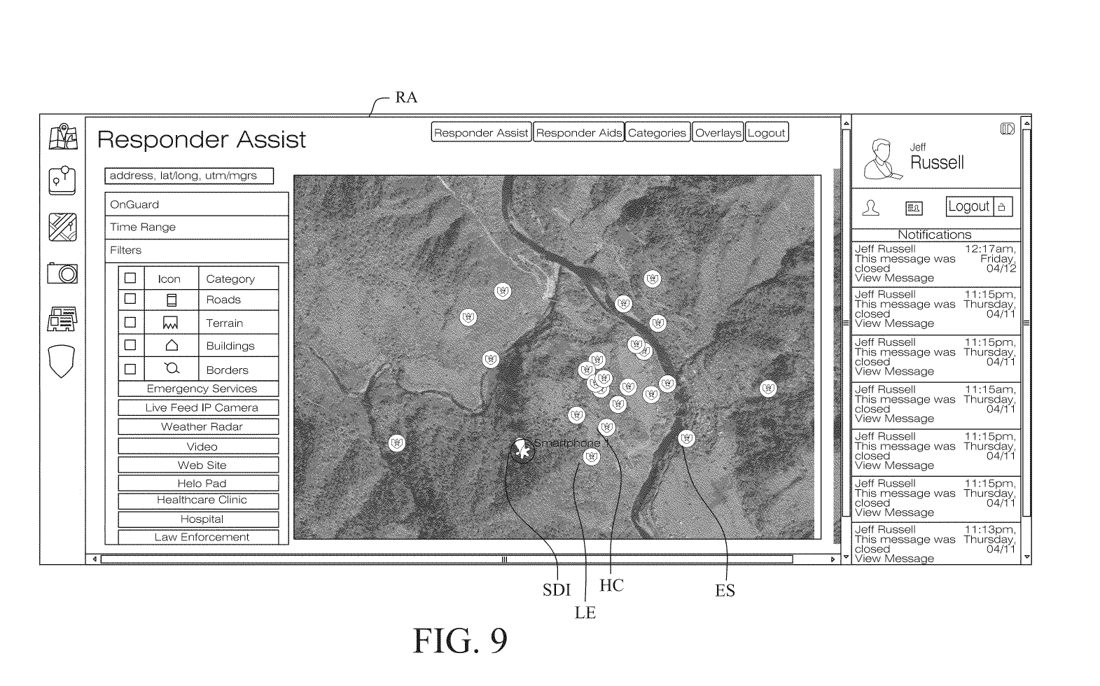

FIG. 9 is a diagram of an example Responder Assist display with one or more agencies identified in the surveillance map. In the example shown in FIG. 9, the display shows a reported incident on “Smartphone1.” In FIG. 9, “Smartphone1” is identified as surveillance device (SDI) where icons near the incident icon show the location of law enforcement (LE) (e.g., white circles with badges), emergency services (ES) (e.g., red medical symbol) and healthcare clinics (HC) (e.g., blue medical symbol). Several layers can be applied to the COP 113. and hospitals, helicopter landing zones, maintenance facilities or anything else of interest can be shown.

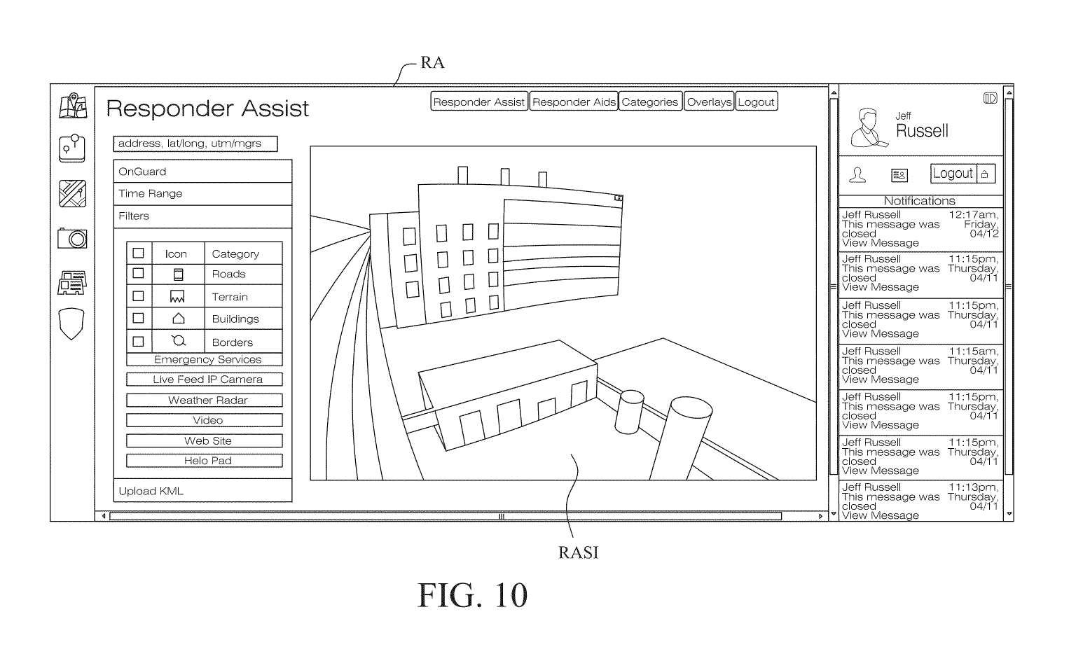

FIG. 10 is a diagram of an example Responder Assist display showing a specific image from a surveillance device. The image shown in FIG. 10 may be an expanded image from the surveillance device when the user selects the image from the surveillance map SM. In the example shown in FIG. 10, Responder Assist Surveillance Image (RASI) shows live image data from a surveillance device at a particular location (e.g., a security camera from a facility). It should be appreciated that the system can display at the same time multiple IP camera feeds from around the world, and if a CCTV camera has Internet Protocol accessibility, that camera can be displayed on the COP 113 as an icon and accessed rapidly.

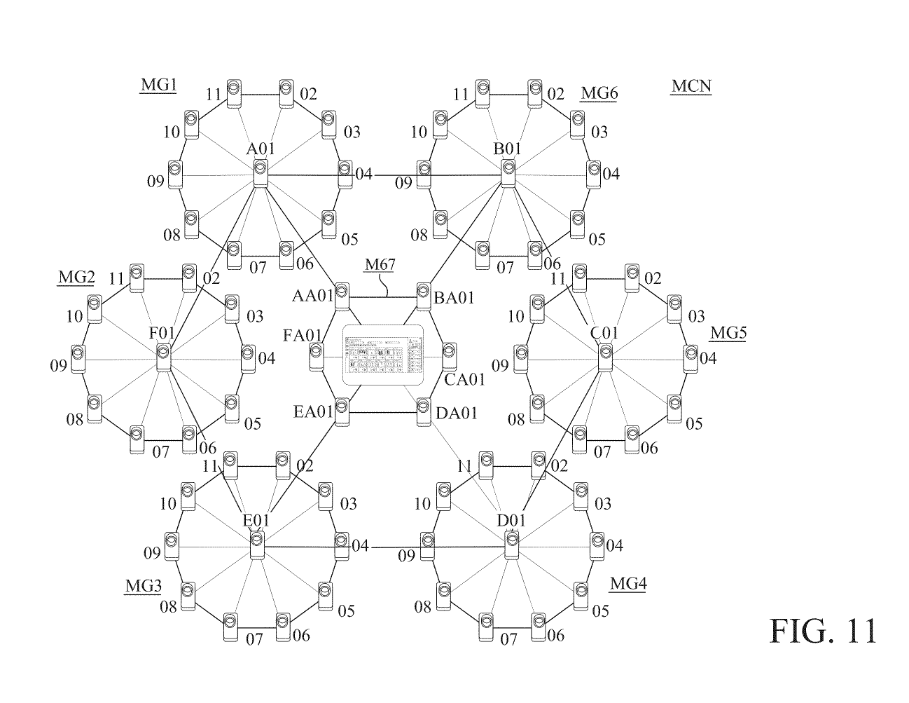

FIG. 11 shows a diagram of an example mobile collection network (MCN). In a non-limiting, example embodiment, the mobile connection network MCN connects many (e.g., thousands of) cellphones into an information gathering network that provides metadata-rich images (e.g., jpeg images) that record events in time and space in a geo-referenced database. The network MCN in the example in FIG. 11 shows information provided from multiple mobile device groups (MGs) MG1-7. Each mobile group then has multiple mobile devices that are capable of capturing image data which is conveyed to and analyzed by the system 100. The system 100 can be used for intelligence gathering in which sources across very large areas may contribute metadata rich images that can be searched, sorted, aggregated and analyzed for persons and activities in time and space. The system 100 can also interact with facial recognition and license-plate reading technology for further surveillance robustness. The system is a geo-referenced database that ingests images; interprets metadata; posts data to a digital map and stores those images/data in a searchable database. By federating the system with license plate reading and facial recognition software that can access the information within the database the subsequent system of systems would be an even better tool for situational awareness; access control and general security purposes.

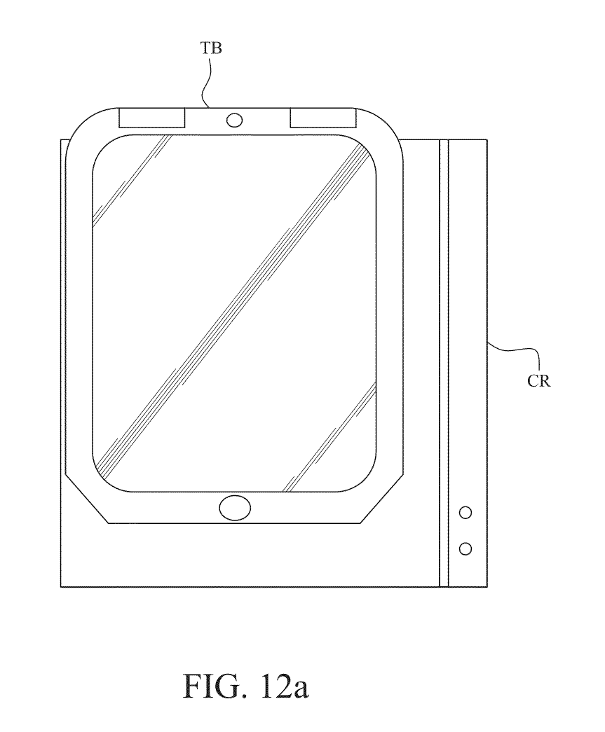

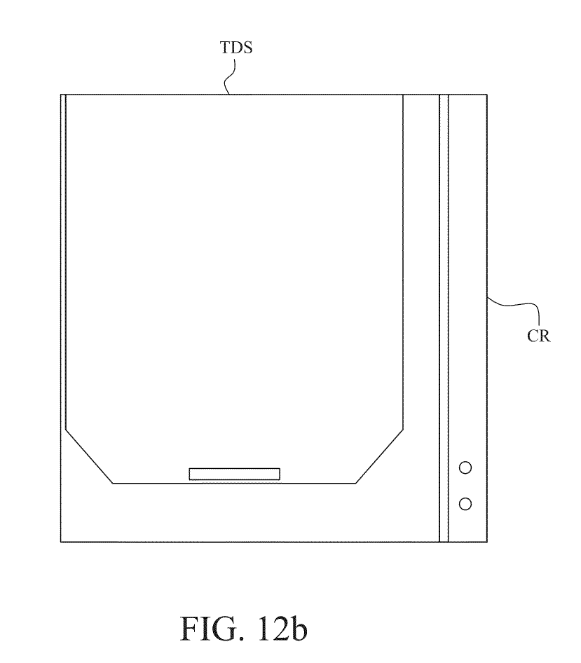

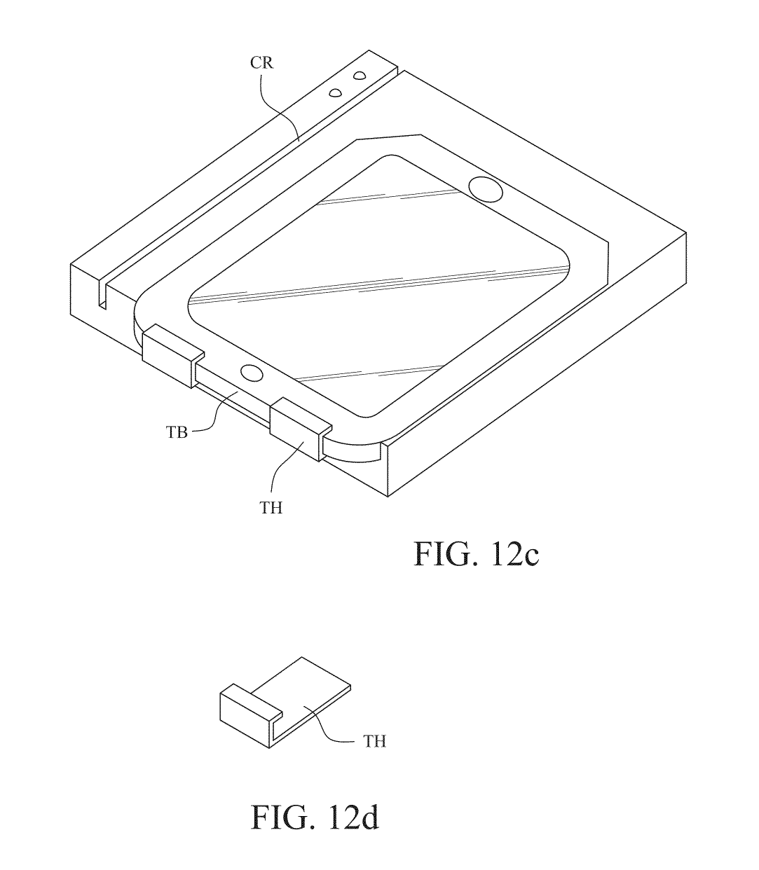

The surveillance system has many different types of applications. One example of a different type of application is now described in conjunction with FIGS. 12(a) and 12(b) which relate to an example tablet credit/debit card security system. In the example shown in FIG. 12(a), a tablet (TB) is coupled to a credit card reader (CR). FIG. 12(b) shows that the tablet TB and carder reader CR can be docked in a tablet docking station TDS and a tablet hook (TH) can be used to mount the system. The tablet TB and credit card reader CR can interact with the system 100 by recording the image of one or more persons using credit, debit and Electronic Benefits Transfer (EBT), (e.g., Food Stamp) cards and store the data/metadata for use by monitoring personnel or other personnel conducting investigations for fraud or other misuse.

When a transaction is made, the card user signs the screen with a stylus or finger and the tablet automatically takes a picture of the card user. The same applies for debit cards in which a number screen appears, and the card user inputs his or her pin where the tablet captures the card user's image when the first number of the pin is input. The captured image of the card user may be sent to the system 100 for storage and analysis. Thus, vendors can issue such tablets to cashiers or other personnel to obtain a record of a person presenting the card for the transaction.

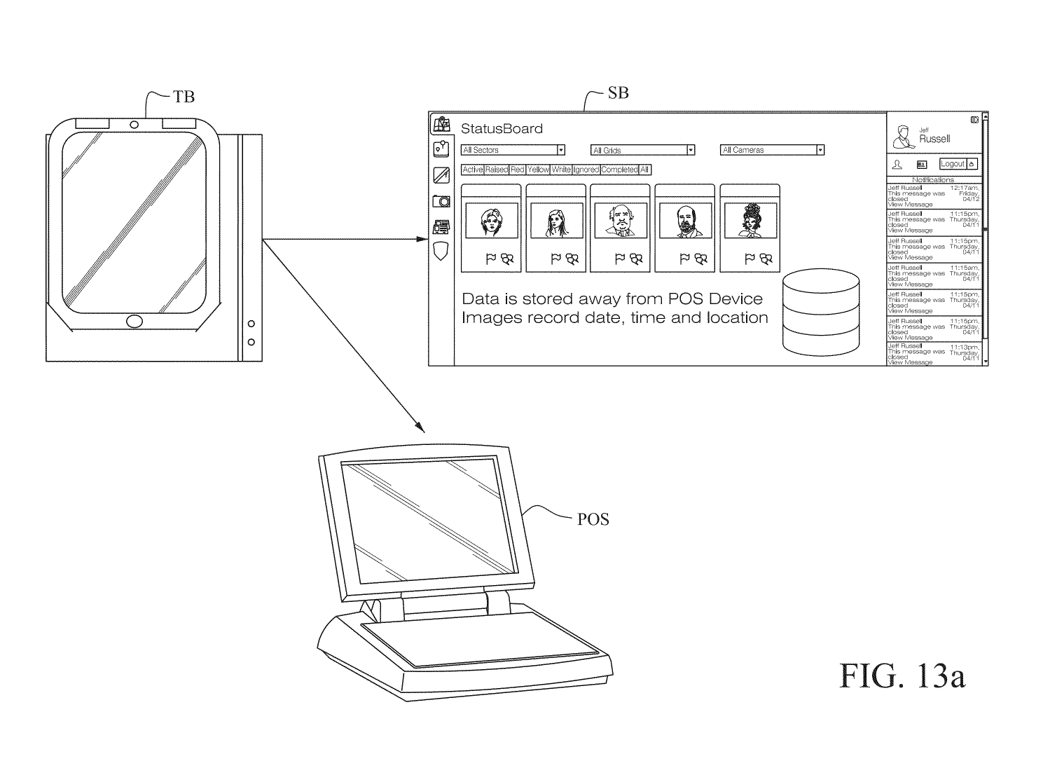

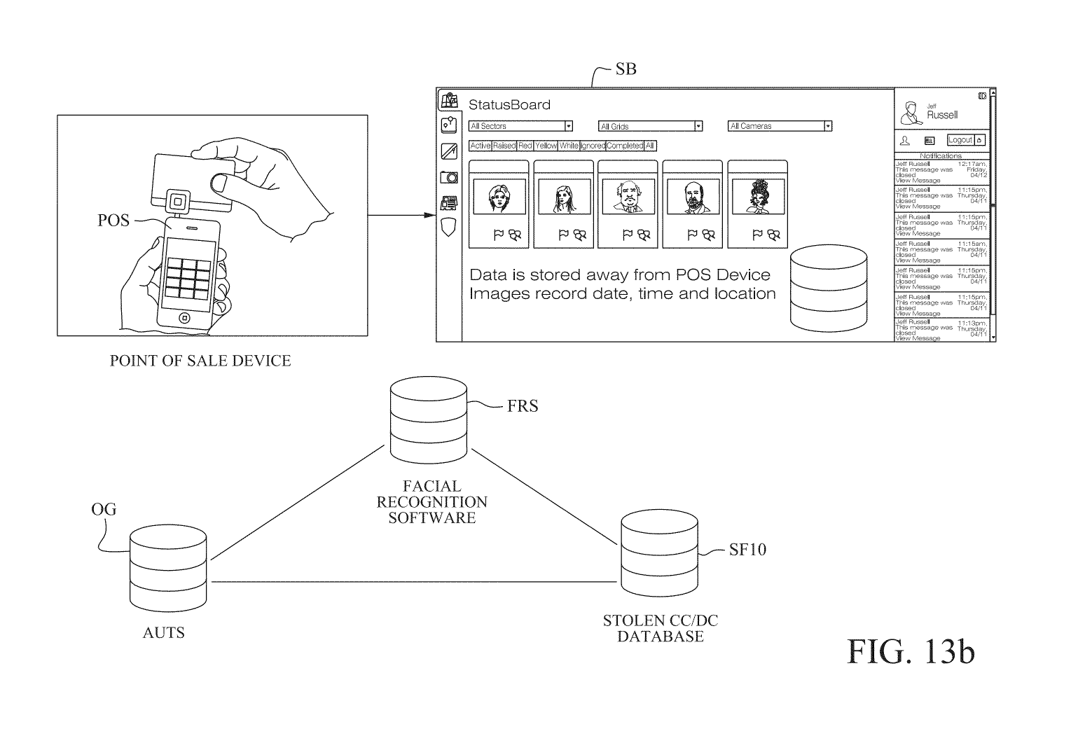

FIGS. 13(a) and 13(b) show a diagram of the example tablet credit/debit card security system communicating with the surveillance system and a point of sale device. As can be seen in FIG. 13(a), the point-of-sale device (POS) operates in conjunction with the tablet TB and card reader CR to communicate image data from the POS device to the system 100. The Status Board 111 can then convey information related to images captured by the devices where date, time, and/or location of the images are recorded.

FIG. 13(b) shows the point-of-sale device POS communicating directly with the system 100. The system 100 is designed such that the system will inhibit collusion between sales staff and those attempting to use stolen debit and/or credit cards. Every transaction can be a searchable data point, and such data points can be stored in cloud storage in perpetuity (or disposed of in accordance with a client's requirements). The system 100 can employ facial recognition software (FRS) to recognize an individual based on the picture of their face taken from the device POS where the information can be stored in a stolen financial instrument database (SFID).

Another application integrates the system 100 with one or more emergency and municipal 9-1-1 systems. For example, a downloadable application may be provided for cell phones that complements municipal 9-1-1 systems. A person can report an accident by taking a picture and sending it to the 9-1-1 Operations Center. The image can be decoded to show time, date, location, altitude, direction that the camera was aimed, type of cell phone used, and other data in which the emergency personnel can act on the data. Such features advantageously support police and security operations in many different scenarios, such as large gatherings (e.g., the Olympics) where there may be language barriers between police/security personnel. Visitors can thus take a picture with their cellphone and transmit the image to an operations center where decisions will be quicker and response times more rapid based upon the information provided in a single image.

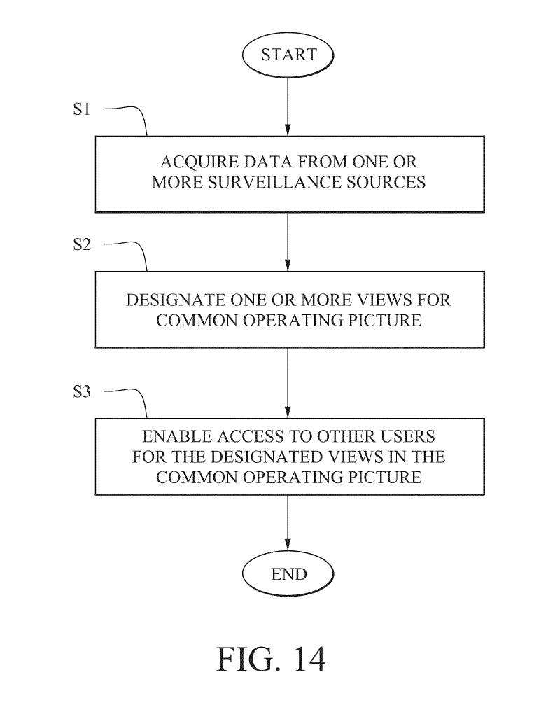

FIG. 14 is a flowchart showing a basic flow of processes for the example surveillance system. The flow of processes can be carried out, for example, by the system 100. The system 100 begins by acquiring data from one or more surveillance sources (S1). As discussed above, the surveillance sources can be a collection of image and/or audio data from one or more cameras and/or other sensors that are captured by the cameras/sensors and then acquired by the system 100. The images are uploaded to a specific Status Board 111 where one or more images can be designed to be shared in the COP 113 (S2). Upon designating the one or more images, the system 100 enables access to one or more other users for the designated images in the COP 113 (S3).

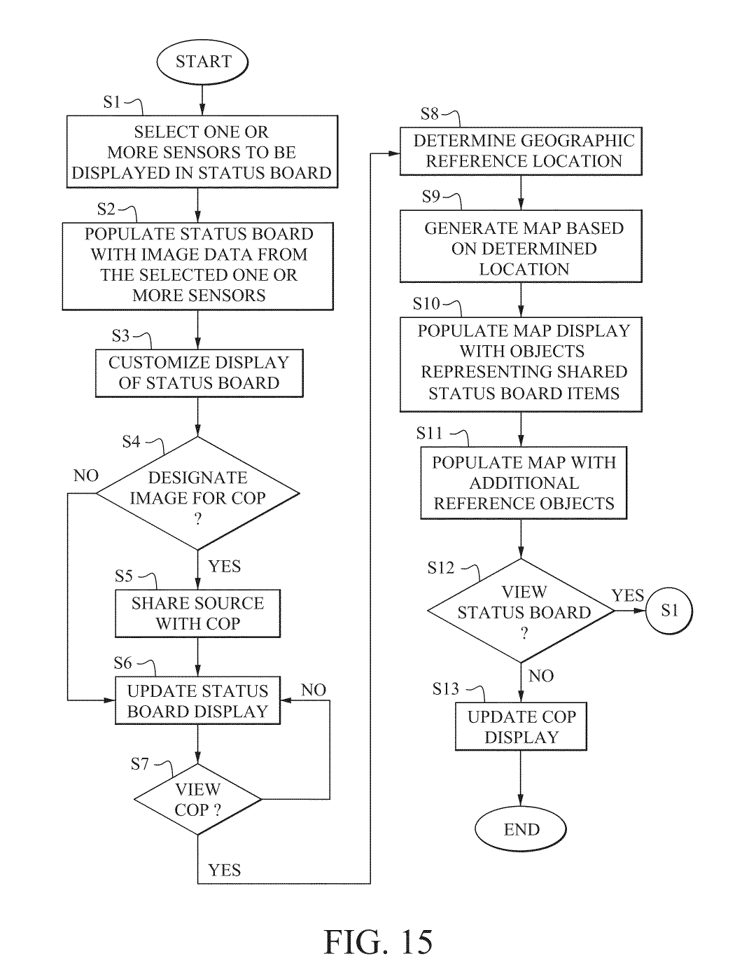

FIG. 15 is a flowchart showing a more detailed flow of processes for selecting and displaying surveillance data for both the Status Board display mode and the COP display mode. The processes implemented in FIG. 15 can be carried out, for example, by the system 100. The system 100 selects one or more sensors to be displayed in a Status Board display for a particular user account (S1). As explained above, the system receives audio/video data from one or more sensors where the data can be communicated over the Internet, for example. A user can access a user interface of the system using a client device in order to select the one or more sensors that are to be displayed in the Status Board.

Upon selecting which sensors are to be displayed in the Status Board, the system 100 populates the Status Board with image data from the selected one or more sensors (S2). A non-limiting example of the sensors that are displayed as image data in the Status Board are shown in FIG. 4, discussed above. Thus, the Status Board in one example can show image data from each of the selected sensors as thumbnail images as well as a supplemental image information including, but not limited to, text describing the image, an indication as to the age of the image, and so on. Through the user interface, the Status Board display can also be customized (S3), e.g., to show only image data from selected sectors, grids, and/or cameras. As another example, the Status Board can also be customized to only show images having certain status indicators (e.g., threat levels such as “red,” “yellow,” “white”).

The system 100, through the user interface, can also select images from one or more sources to be designated to the COP display (S4). If an image is selected to be designated to the COP display, the source is shared with the COP 113 using the Communications Bridge 112 (S5). If no images are selected, the Status Board display can refresh to update any changes in customization or any changes in the image data (S6).

The system 100 can also switch the display on the user interface to show the Common Operating Platform which contains data in the COP 113 (S7). In generating the Common Operating Platform, the system 100 can first determine the geographic reference location (S8). This location can be determined based on an actual location of the user (e.g., derived from GPS, IP address information, etc.) as well as location information provided from the user (e.g., manually input location information). Upon determining the geographic reference location, the system 100 can generate a map based on the determined location (S9). The map generally shows the area corresponding to the determined geographic reference location and can be adjusted to “zoom-in” and “zoom-out” on the displayed location.

After the map is generated, the system 100 populates the map display with objects representing the shared Status Board items (S10). An example of the map having objects representing the shared Status Board items is shown in FIGS. 7-9 discussed above where one or more icons represent the shared Status Board sources. With the shared Status board items, the map can also be populated with additional reference objects (S11) including, but not limited to, icons representing different municipal agencies such as police stations, fire stations, hospitals, and/or other agencies or businesses. These icons may represent the locations of the different municipal agencies so that the user can visually see or determine how far the source is from the particular agency.

Just as the system can transition from the Status Board display to the Common Operating Platform display, the system can also freely switch back to the Status Board display (S12) upon designation or indication by a user. If the system switches back to the Status Board display, the system returns to initializing and setting up the Status Board display (S1). Likewise, if the system does switch to the Status Board display, the system can update the Common Operating Platform display (S13).

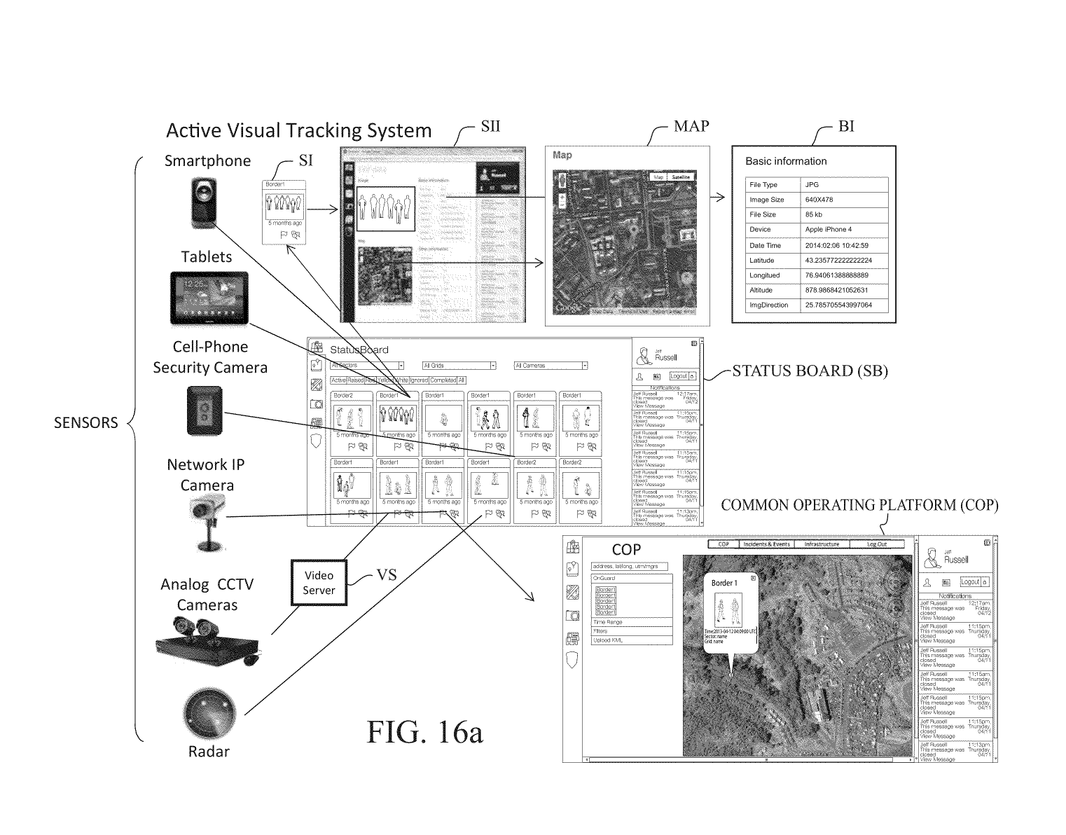

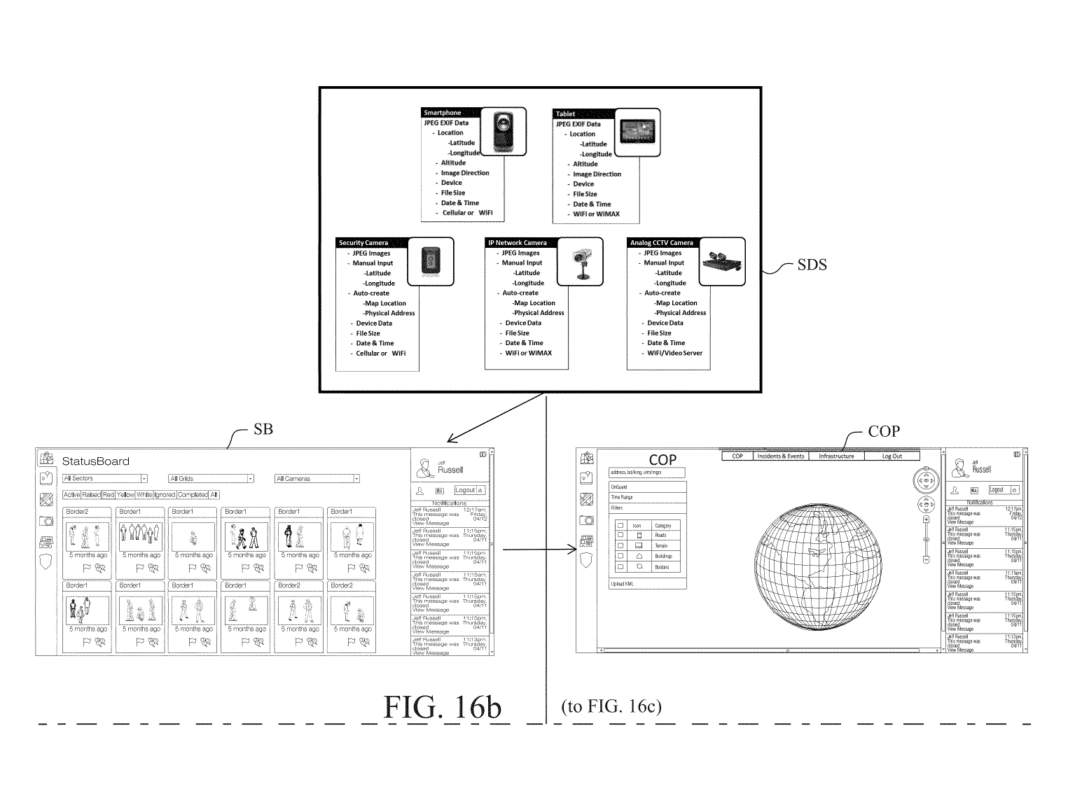

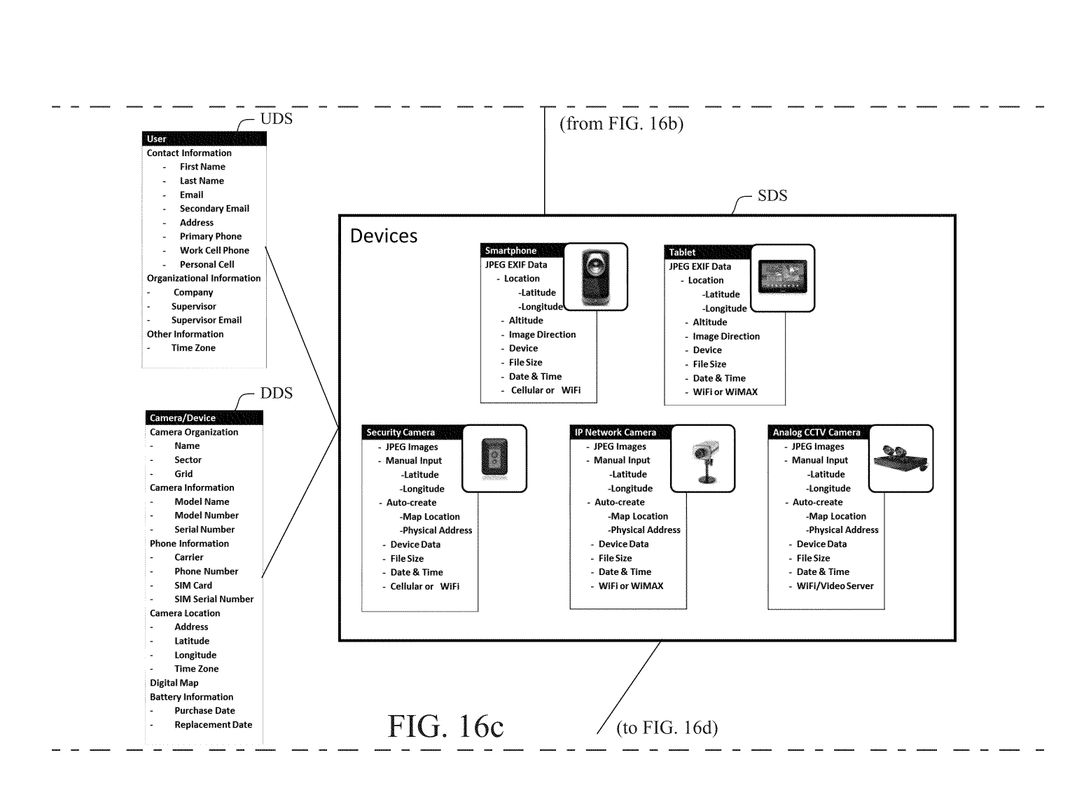

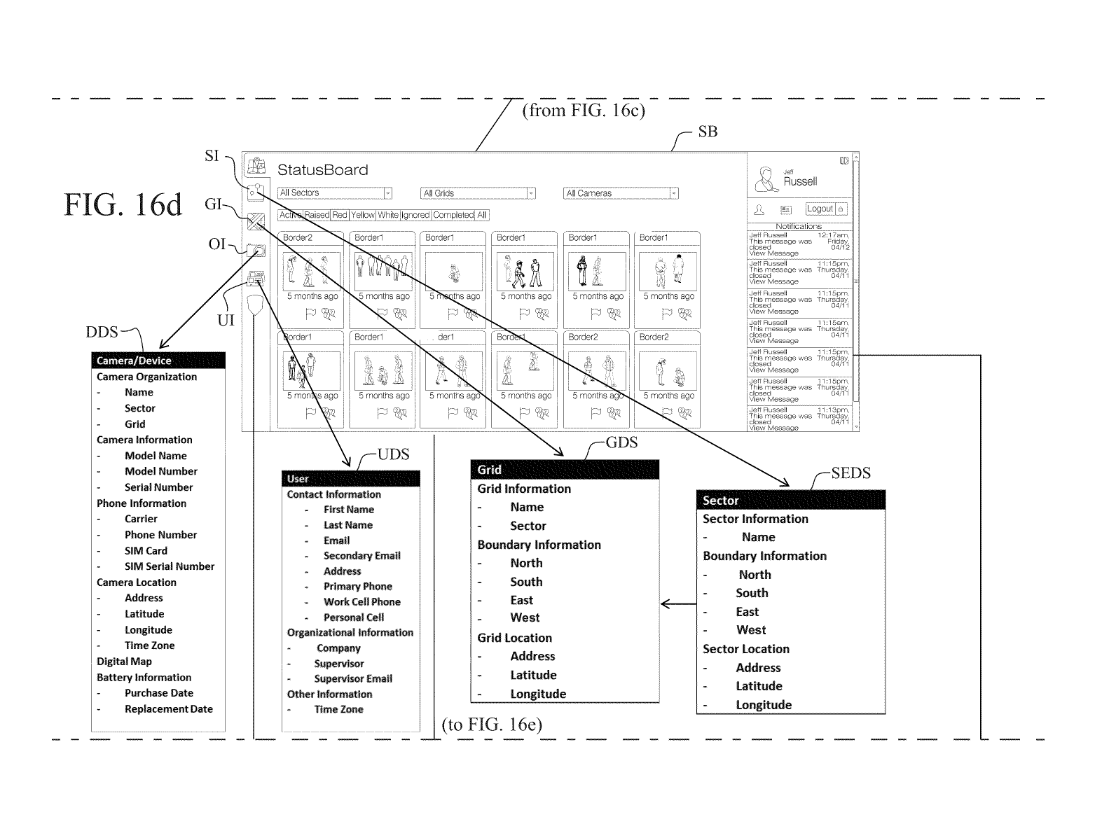

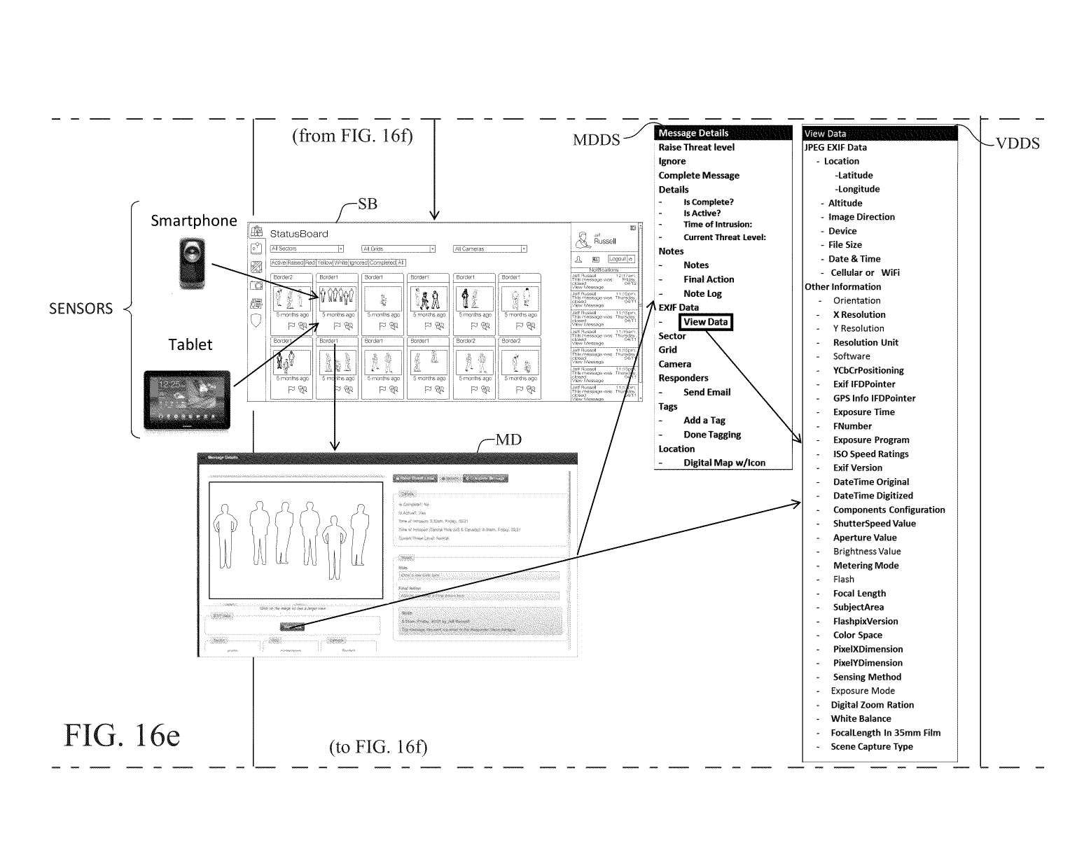

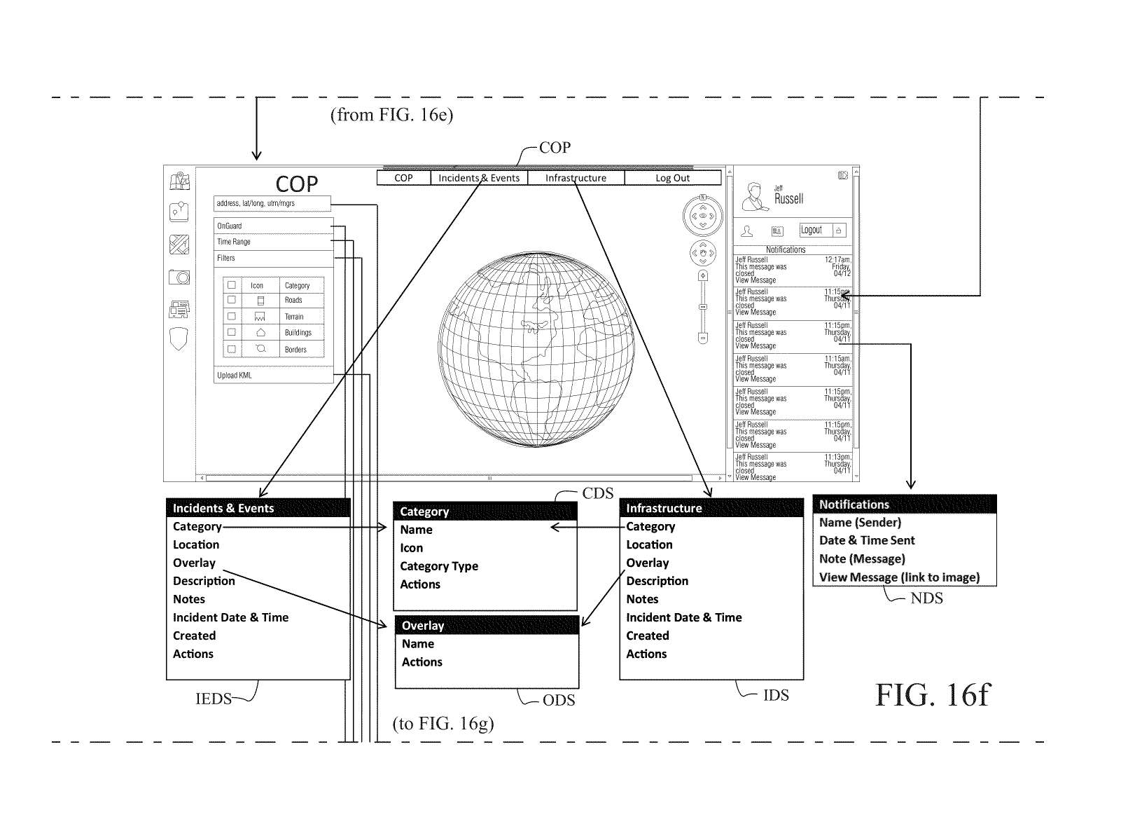

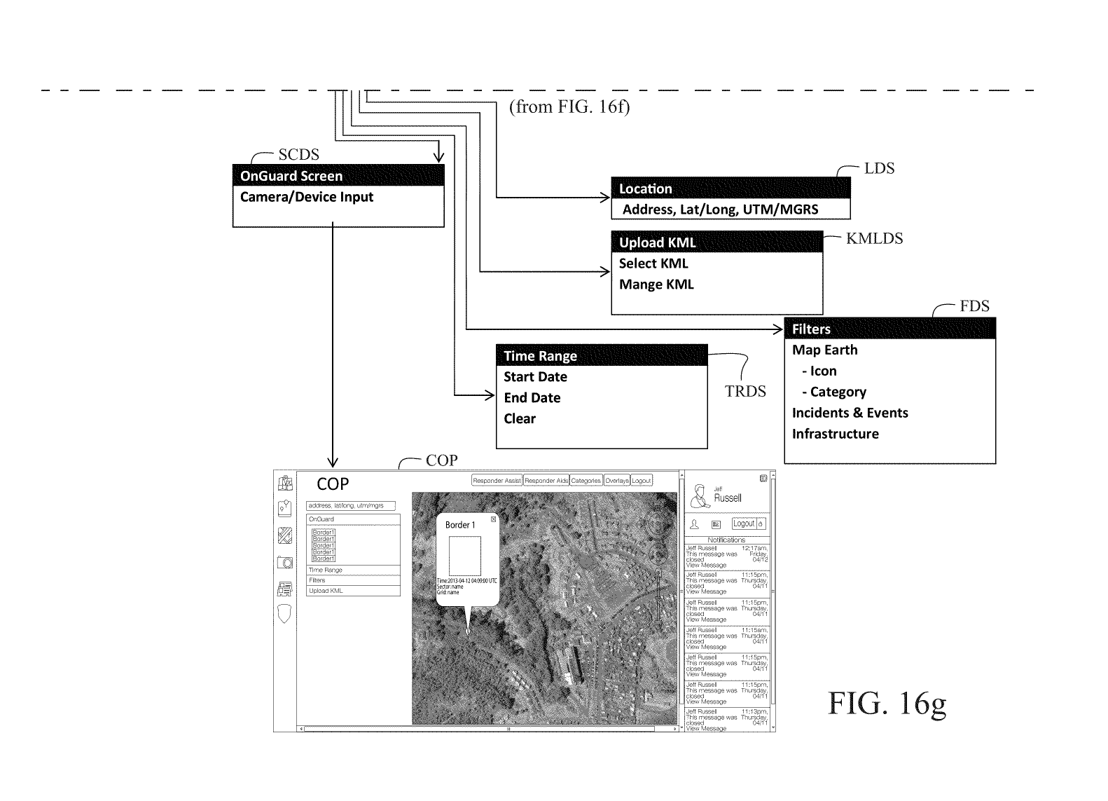

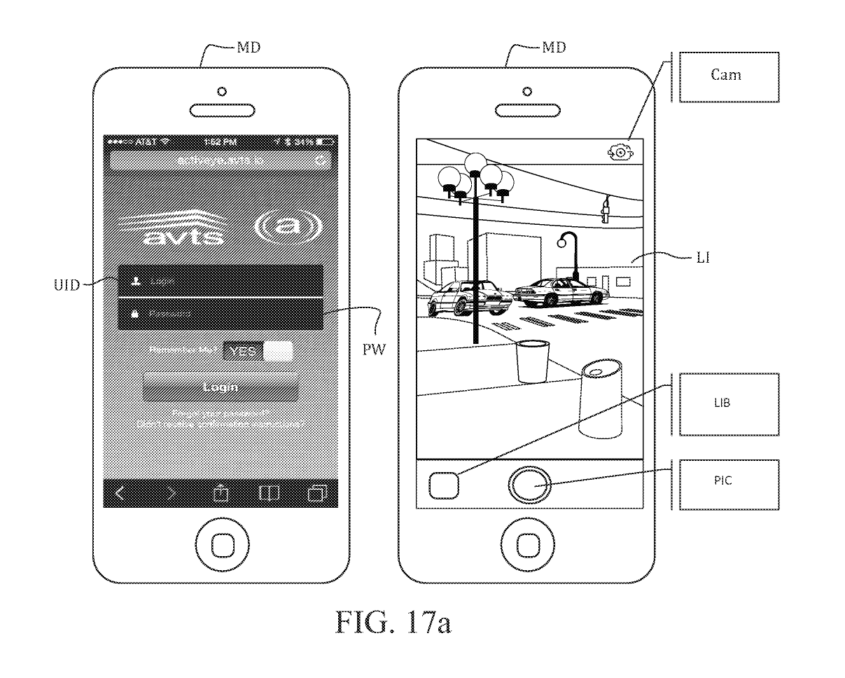

FIGS. 16a-g show diagrams of an example application architecture for maintaining and creating the methods and systems described above. FIGS. 16a-g represent various example functions and processes that are called and accessed by the system in processing the data from the various sources and generating the user interface as viewed by the client devices. FIGS. 16a-g thus show how different aspects of the system interact with different device (e.g., sensors) and the corresponding data structures used/accessed in this process.

FIG. 16a illustrates a diagram of the Status Board SB interacting with both the COP and the Sensors. As described above, the Status Board SB is populated with images captured by the different sensors which include, but are not limited to, smart phones, tablets, security/surveillance cameras, network IP cameras, analog CCTV cameras, and/or radar. It should be appreciated that the images captured from the CCTV cameras could be processed and/or made digital using a video server VS.

The Status Board SB contains one or more surveillance images SI in which each image is accessible (e.g., by selecting the image using the user interface) to expand the image to show greater information (surveillance image information SII). The surveillance image information SII can provide more detail of the selected image including, but not limited to, a larger version of the image itself, a map location MAP showing the location of the image/source on a map, and/or basic information BI which provides information related to the image (e.g., file type, image size, file size, device image was taken from, date/time image was taken, latitude, longitude, and/or altitude). Thus, the interface allows a user to easily view images from multiple surveillance sources and expand further detail from the images by “drilling down” into each image. The further detail thus provides the user with more information related to where and when the image was captured and possibly even information relating to the content of the image. It should also be appreciated that one or more of the images could be selected to elevate the status of the image for marking/display on the COP. This would allow a user viewing the COP to see the image (e.g., representing an incident) at the location on a map.

FIG. 16b illustrates certain non-limiting example data structures used for the data provided from the Sensors. FIG. 16b shows a basic implementation where images can be “posted” from the image capturing sources to the “ActiveEye Portal” using a mode of communication (e.g., MMS, FTP) and then some (or all) images are posted to an “ActiveShield” COP. As discussed above, Sensors are configured to capture audio/video/image data in which the data can be “posted” to the Status Board SB and/or shown on an image map in the Common Operation Platform COP. The example shown in FIG. 16b shows corresponding surveillance data structures SDS used in the image data captured from each sensor. For example, smart phones and tablets can create JPEG encoded files with exchangeable image file format (EXIF) metadata that provides information related to each image. This information can include, but is not limited to, an image location (including latitude and longitude), image altitude, image direction, the device used in capturing the image, file size, date/time the image was captured, and the communication mode in which the image was transmitted/posted (e.g., cellular, WiFi, WiMAX). The data structures for the images captured from other devices could have similar attributes with minor differences. For example, security cameras, IP network cameras, and analog CCTV cameras could provide information in their data structures including, but not limited to, JPEG image data, location data manually input (e.g., latitude and longitude), auto-created map data (e.g., map location, physical address), device data, file size, date/time the image was captured, and/or communication mode (e.g., cellular, WiFi, WiMAX, Video Server). This information can be stored in the system for any variety of uses including displaying the information when a user chooses to obtain it (i.e., by selecting an image for further detail). The information could also be incorporated into a data file to be transferred to one or more systems for any variety of uses.

FIG. 16c illustrates further information that could be associated with each image and/or a collection of images together taken from the different sensors. The surveillance data structure SDS could include associated data that is associated with each individual image and/or a collection of images from a common overall source (e.g., a user). This associated data could include a user data structure UDS as well as a device data structure DDS. The user data structure UDS could include information related to a user including, but not limited to, a user first name, last name, email address, one or more additional email addresses (e.g., secondary email address), one or more home mailing addresses, and/or one or more phone numbers (e.g., primary phone, work cell phone, personal cell phone). Additional information in the user data structure UDS could include organization information related to the user's place of employment (e.g., company, supervisor, contact information of supervisor including an email address) as well as other information relevant to the user (e.g., user location information including a time zone the user is normally or currently present).

The device data structure DDS could include information related to each device capturing a particular image. For example, each device (e.g., smart phone, tablet, security camera, IP network camera, analog CCTV camera) could have a data structure associated with it providing information related to the device. This information could include, but is not limited to, camera organization including a name of the device, sector the device is located, and/or grid the device is located; camera information including a model name, number, and/or serial number; phone information (if relevant) including carrier name, phone number, SIM card, and/or SIM serial number; camera location including address location of the camera, latitude and longitude of the camera position, altitude of the camera location, and/or a time zone in which the camera is located; digital map information; and/or battery information including a battery purchase data and/or replacement date. This information could be included with the data structures of each individual image and/or associated with a collection of images. Likewise, this information could be accessible in a database table and cross-referenced by identifiers included in each image.

FIG. 16d depicts further data structures associated with different elements presented on the status board SB. As discussed above, the status board SB interface presents several selectable options (some of which are displayed on the left portion of the interface in this example). When selected, these options can show information linked to these particular data structures. For example, when device information DI (shown as a “camera” icon in this example) and user information UI are selected, the information associated with device data structure DDS and user data structure UDS, as discussed in more detail above. Likewise, when grid information GI and sector information SI are selected, information associated with grid data structure GDS and sector data structure SDS can be displayed or conveyed to a user in some manner. The grid data structure GDS can be associated with a particular grid location the user has selected to view and/or capture image data. The grid data structure GDS can show information including, but not limited to, grid information including grid name and sector; boundary information including a north boundary, south boundary, east boundary, and/or west boundary; and/or grid location including address, latitude, and/or longitude. The sector data structure SDS can be associated with a sector within a grid (e.g., a subset of a grid) and can display information including, but not limited to, sector information including a sector name; boundary information including a north boundary of the sector, a south boundary, an east boundary, and/or a west boundary; and/or sector location information including an address, latitude, and/or longitude. It should be appreciated that a grid is a sub-set of a sector and a sector represents one unit of a geographical location in the world. For example, a sector could represent a city within a state (e.g., Arlington, Va.) where a grid could represent a particular neighborhood within the city (e.g., the Ballston neighborhood). The information for each grid and sector could provide details regarding the geographical boundaries of each (e.g., using latitude/longitude coordinate data).

FIG. 16e shows further details regarding the data structures associated with other elements presented in the status board SB. As discussed above, different messages can be presented along the status board SB display to convey information related to one or more surveillance sources. When the information is a message is expanded, a message detail MD screen can be displayed showing further details related to the message (described in further detail above). The message detail MD screen can be associated with message detail data structure MDDS which comprises information including, but not limited to, raise threat level; ignore; complete message; details including an is complete flag, is active flag, time of intrusion, and/or current threat level; notes information including notes of the message, final action, and/or note log; EXIF data including a link to the view details data structure VDDS; sector; grid; camera; responders including send email; tags including add a tag flag/component and/or done tagging flag; and/or location including digital map with icon. The message details can provide messages (including images) to any number of users in a near instantaneous manner.

The view details data structure VDDS can provide further detail information related to the image presented in the message detail MD screen. For example, the view details data structure VDDS can convey information including, but not limited to, JPEG EXIF data including location (i.e., latitude and/or longitude), altitude, image direction, device, file size, date/time, and/or communication mode (e.g., cellular, WiFi); and/or other information including orientation, X resolution, Y resolution, resolution unit, software, YCbCrPositioning, EXIF IFDPointer, GPS Info IFDPointer, Exposure Time, FNumber, Exposure Program, ISO Speed Ratings, EXIF version, Date/Time Original, Date/Time Digitized, Components configuration, Shutter speed value, Aperture value, Brightness value, Metering mode, Flash, Focal length, Subject area, Flashpix version, Color space, PixelXDimension, PixelYDimension, Sensing method, Exposure mode, Digital zoom ration, White balance, Focal length in 35 mm film, and/or Scene capture type. While these data structure can be associated with the interface and processes associated with the status board SB, several data structures are also associated with the common operating platform COP. The view details data structure is normally tied to a particular image (e.g., one data structure per image).

FIG. 16f illustrates further example data structures associated with the common operating platform COP. In the example shown in FIG. 16f, the COP has data structures associated with incidents & events (the incidents and events data structure IEDS) and data structures associated with the infrastructure (the infrastructure data structure IDS). Both the IEDS and IDS are associated with further data structures: category data structure CDS and overlay data structure ODS. The information in incidents and events data structure IEDS includes, but is not limited to, category (which links to category data structure CDS); location; overlay (which links to overlay data structure ODS); description; notes; incident date/time; created; and/or actions. The information in infrastructure data structure IDS includes, but is not limited to, category (which links to CDS); location; overlay (which links to ODS); description, notes, incident date/time, created, and/or actions. The category data structure CDS comprises information including, but not limited to, a category name, icon, category type, and/or actions, and the overlay data structure ODS comprises information including, but not limited to, overlay name and/or actions. It should be appreciated that the incidents & events structure is tied to particular events as they are occurring where the infrastructure is normally tied to physical structures (e.g., police, hospital, train). It should be further appreciated that the category data structure CDS is normally tied to a particular type of category of event (e.g., murder, assault, robber, etc. . . . ) where the overlay data structure ODS is normally tied to broader general groups (e.g., crime, emergency, etc. . . . ).

FIG. 16g shows further data structures associated with the common operating platform COP. These data structures include a COP screen data structure SCDS including camera/device input; a location data structure LDS including address, latitude/longitude, UTM/MGRS; an upload KML data structure KMLDS including select KML and/or manage KML; a time range data structure TRDS including start date, end date, and/or clear; and/or a filters data structure FDS including icon, category, incidents & events, and/or infrastructure. It should be appreciated that the data structures described above are non-limiting and the system envisions incorporating both more and less data structures.

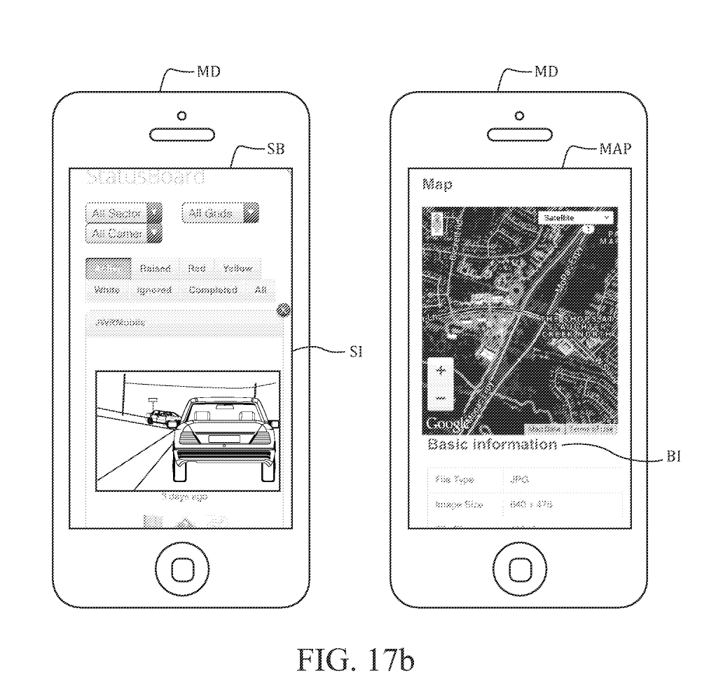

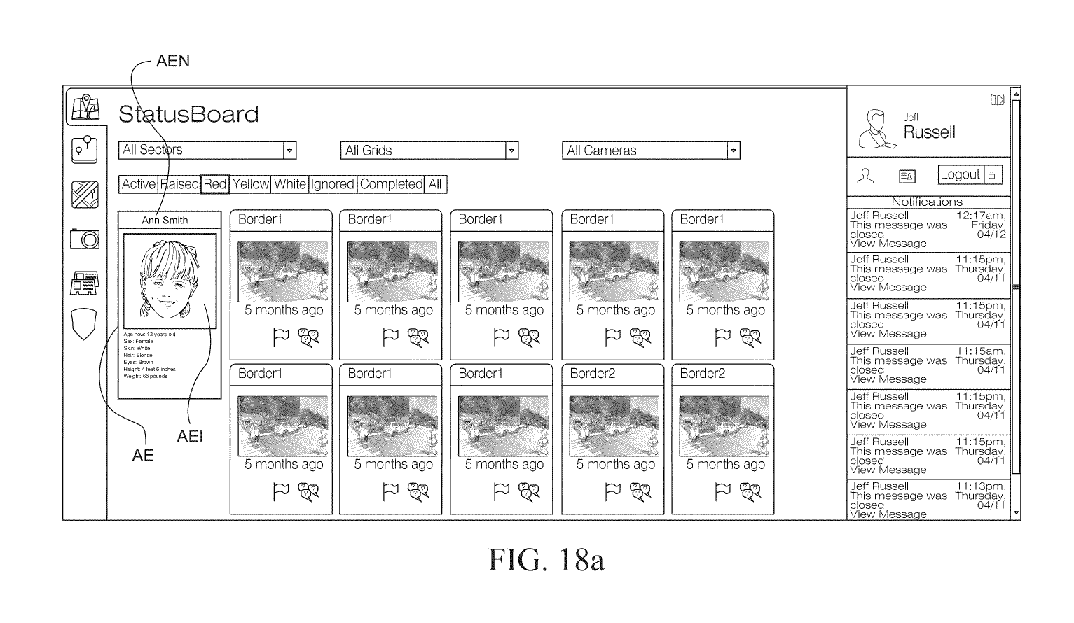

FIG. 17a illustrates a non-limiting example application that can employ the techniques of the system described in this specification. The application can be obtained and used on any type of mobile/portable device MD (e.g., smart phones, tablets) and can utilize all or more of the features of the system as described above. Similar to the user interface shown above, the user can log-in to the system by providing a user ID UID and a password PW in the prompts shown in FIG. 17a. The application allows the user to quickly take images using their mobile device MD (e.g., using the application or the application associated with the camera on their mobile device) and each application can be registered and licensed to a client. The application can show a camera facing button CAM for selectively choosing which camera on the mobile device MD to use (e.g., front, back), an access photo library button LIB for accessing a photo gallery of captured images, and/or a capture photo button PIC for capturing the photo using the camera's imaging device. The images initiated from the application are transmitted securely (and can be sent automatically without user action) after the image has been taken. The images can automatically enter the COP for further processing and the application can also provide the user the ability to add notes and alert levels.

FIG. 17b shows further example features of the application displayed and used on the mobile device MD. In the example shown in FIG. 17b, the status board SB is displayed showing one or more of the surveillance images SI that are also displayed on the full user interface. Likewise the map from the common operating picture MAP and basic information BI are also displayable and accessible on the application. The functionality is similar to the user interfaces described above and allows a user to access all of the same features as if they were accessing the normal user interface.

Having access to the system using an application available for a mobile device is advantageous because it allows users to quickly populate their status boards SB as well as the common operating picture COP by imaging incidents and events as they occur. The application can allow someone to take a picture of an event using their phone, for example, in which the image will be quickly posted to the system and made available, if necessary, to other users and/or the authorities. This could be advantageous in situations where large crowds are present and the user would like to quickly notify the authorities of an event that occurred. For example, several large athletic events including marathons and the Olympics have had situations where emergency services are required. This could range from something as simple as a pedestrian being injured or needing help, to something more catastrophic such as a terroristic act. By having the application readily available on a mobile device, a user can capture and convey an event as it is occurring so that the authorities will be immediately notified of an incident. The image would convey a visual display of what is occurring and the user could also optionally add dialogue or some type of message to associate with the image. This allows the system to effectively act as a roaming surveillance source throughout the world where each individual user has the ability to capture and convey images showing different incidents and events as they occur so that, where necessary, the proper authority can be alerted.

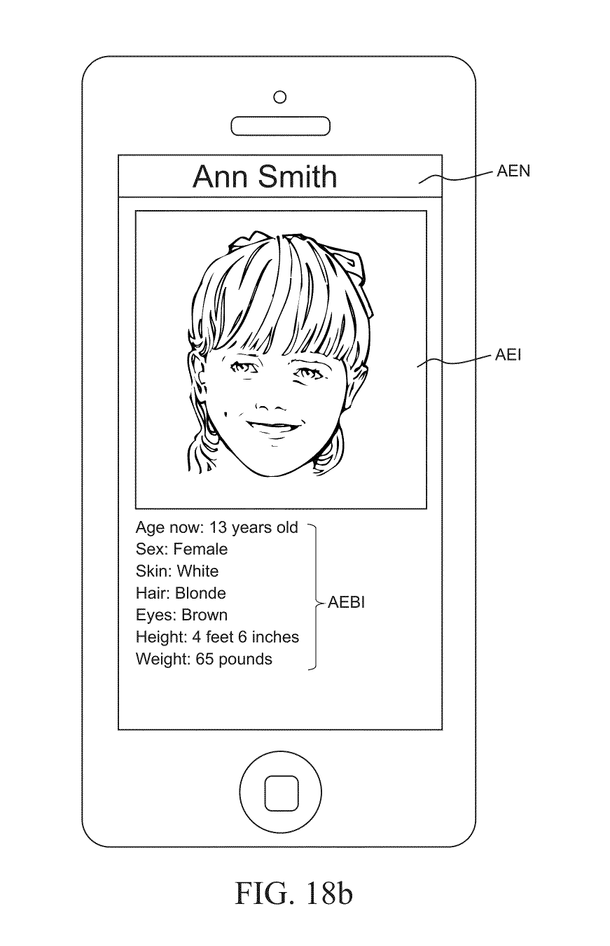

FIGS. 18a and 18b show amber alert features that can be displayed using both the normal user interface as well as the interface on the mobile application. In FIG. 18a, the status board SB shows an amber alert AE for the individual identified by amber alert name AEN and corresponding amber alert image AEI. The status board SB can rapidly transmit the amber alert AE notifications to anyone using a 911 service/application and thus, civil authorities can reach a greater number of people in a shorter amount of time.

The amber alert can be selected to display further details (enlarged and shown, for example, in FIG. 18b) including amber alert basic information AEBI. As can be seen in FIGS. 18a and 18b, the amber alert basic information AEBI can provide further information for the individual in the amber alert AE including, but not limited to, age, sex, skin color, hair color, eye color, height, and/or weight. Of course, further information could be provided and this list is non-limiting. The amber alert AE, like many features provided by this system, allows for rapid conveying of emergency information to users of the system so that they may use the system to help find and track the location of an individual. This can be particularly advantageous in situations where the individual has been abducted and the user captures their image and/or location but is hesitant to engage the individual (e.g., because the abductor is present and armed/dangerous). By simply capturing an image of the individual, the COP can track and convey the information to other users and, more importantly, to law enforcement so that they may quickly advance on the individual's position to rescue him/her.

The example surveillance system described provides a geo-referencing database for metadata rich images that define events, incidents, phenomena and static entities (infrastructure) in time and space through directly ingesting images from sources or devices enrolled into the system and by drawing on other information sources to add context and increase understanding of an event, incident, phenomenon or static entity. The system further uses information from other sources including, but not limited to, Keyhole Markup Language (KML) files, other converted GIS protocol files, Internet Protocol-enabled Closed Circuit Television camera feeds, radar images, RSS news feeds, and subjective/objective reporting directly on the system by users. The system creates and stores thematic overlays applied to a base map at the discretion of the system user and also stores images in a searchable database. The system receives images with minimal latency giving near-real time visual reports and can rapidly communicates information to pre-designated recipients through emails and text messages. The system can also communicate with certain types of sensor/cameras commanding those cameras to arm/disarm, report statuses and report location, and can also be used to remotely control Pan-Tilt-Zoom CCTV cameras. The data storage employed by the system is preferably structured and sequenced in a manner that facilitates rapid analysis of incidents. Such analysis may include statistical analysis such as regression analysis, analysis of variance, and correlation and pattern analysis based upon examining activities over time and by location.

Some of example applications include widespread distribution of cellphone applications that feed into the system storing and displaying geo-tagged images. The cellphone based image distribution will also complement municipal 9-1-1 systems as a downloadable “app” that all citizens can use to report incidents and crimes to 9-1-1 operations centers. This application allows for more rapid decision making and distribution of information. As described above, the system may also mitigate financial crimes by helping to identify the users of stolen credit and debit cards. The system can capture the image of persons conducting credit or debit cards transactions in secure cloud storage and if the credit or debit card is lost or stolen there is a record of the transaction (with image) stored away from the Point-Of-Sale machine/system. This can prevent collusion between staff and the persons committing fraud.

It should be appreciated that the example surveillance system is capable of controlling electro-optical infrared (EO/IR) cameras and the system and cameras operate in all weather conditions. For example, the example surveillance system is capable of both optical and acoustic surveillance at ranges in excess of 100 meters for personnel. The surveillance system also takes advantage of “sensors” that transmit via existing infrastructure (cellular, WiFi or WiMAX networks) where the system presents images/data for evaluation (to cell phones and on a secure web site). The system can also accommodate different camera/sensors where more sophisticated sensors can operate in a meshed field. For example, the field can be put to sleep remotely to save power and when one sensor is awakened it can alert the other sensors in the field by telling them to “wake up.” Each sensor can be interrogated/commanded remotely as to its power reserves and location and operators can set sensors for both still pictures and video feed depending upon conditions and requirements. All of the systems that are “enrolled” into the AVTS system contribute in near-real time situational awareness and understanding by creating a single source for collecting and storing images and information and rapidly communicating that information to users and other interested parties via electronic mail and by posting relevant notes on the system's “notification (chat) bar.”

While the technology has been described in connection with example embodiments, it is to be understood that the technology is not to be limited to the disclosed embodiments, but on the contrary, is intended to cover various modifications and equivalent arrangements.

1. A system for generating a common operating platform of a surveillance system for display by remote client devices, the system comprising:
a processing system having at least processing circuitry, the processing system configured to:
generate, for display on a display device, a client-specific status board having a customized surveillance platform including multiple display views from multiple surveillance sources, each of the multiple display views being associated with a time and place,
generate, for display on the display device, the common operating platform comprising a map having multiple display views from multiple surveillance sources that are provided by the client devices, and
communicate, in response to an operation input, one or more display views in real-time between the client-specific status board and the common operating platform.

2. The system according to claim 1, wherein a user can access the common operating platform based on display views and provide input data to the common operating platform.

3. The system according to claim 1, wherein the one or more processors are further configured to:
set a status indicator for a view of the one or more display views shared between the common-surveillance system and the client-specific status board; and
display the status indicator along with the shared view in the common-surveillance system and/or the client-specific status board.

4. The system according to claim 1, wherein the one or more processors are further configured to:
associate a description for a view of the one or more display views shared between the common-surveillance system and the client-specific status board; and
display the description along with the shared view in the common-surveillance system and/or the client-specific status board.

5. The system according to claim 1, wherein the one or more views originate from one or more mobile imaging devices that are configured to record an event indicating at least a time and a location of the event.

6. The system of claim 1, wherein the one or more processors are further configured to:
image one or more payment cards using the one or more surveillance sources;
generate data related to the one or more payment cards; and
store the generated data and the imaged one or more payment cards in a database.

7. The system of claim 1, wherein the one or more processors are further configured to submit at least one image generated from the one or more surveillance sources to an emergency facility, the at least one image encoded to provide information relevant to an event requiring services of the emergency facility.

8. The system of claim 7, wherein the encoded information comprises at least one of a time of the event, a date of the event, a location of the event, an altitude of the surveillance source, a direction being viewed by the surveillance source, and/or a type of surveillance source.

9. The system according to claim 1, wherein the one or more display views from the one or more surveillance sources represent a single location.

10. The system according to claim 1, wherein the one or more display views from the one or more surveillance sources represent multiple locations.

11. A system, comprising:
one or more geo-reference databases configured to store image data from one or more imaging devices; and
a computer-implemented user interface configured to access the one or more geo-reference databases so that at least some of the stored image data may be presented via the user interface on a display device, the computer-implemented user interface configured to:
generate a status-board display showing one or more images relating to a time and/or location of a display view imaged from the one or more imaging devices, the status-board display being accessible to a specific client computer;
generate a common-operating platform showing one or more images having a time and/or location associated with each image, when the common-operating platform is globally accessible to multiple client computers via one or more data communication networks;
designate, based on a user input, one or more images to be shared real-time via a bridge between the status-board display and the common-operating platform, the one or more images being represented in a first manner on the status-board display and represented in a second manner in the common-operating platform.

12. The system of claim 11, wherein the one or more images are represented in the first manner by showing thumbnail views of the one or more images.

13. The system of claim 11, wherein the one or more images are represented in the second manner by showing icons in a map based view corresponding to the one or more images.

14. A method implemented using an information processing apparatus having one or more processors and for generating a common operating platform of a surveillance system for display by remote client devices, the method comprising:
generating, for display on a display device, a client-specific status board having a customized surveillance platform including multiple display views from multiple surveillance sources, each of the multiple display views being associated with a time and place;
generating, for display on the display device, the common operating platform comprising a map having multiple display views from multiple surveillance sources that are provided by the client devices; and
communicating, in response to an operation input, one or more display views in real-time between the client-specific status board and the common operating platform.

15. The method according to claim 14, wherein a user can access the common operating platform based on display views and provide input data to the common operating platform.

16. The method according to claim 14, further comprising:
setting a status indicator for a view of the one or more display views shared between the common-surveillance system and the client-specific status board; and
displaying the status indicator along with the shared view in the common-surveillance system and/or the client-specific status board.

17. The method according to claim 14, further comprising:
associating a description for a view of the one or more display views shared between the common-surveillance system and the client-specific status board; and
displaying the description along with the shared view in the common-surveillance system and/or the client-specific status board.

18. The method according to claim 14, wherein the one or more views originate from one or more mobile imaging devices that are configured to record an event indicating at least a time and a location of the event.

19. The method of claim 14, further comprising:
imaging one or more payment cards using the one or more surveillance sources;
generating data related to the one or more payment cards; and
storing the generated data and the imaged one or more payment cards in a database.

20. The method of claim 14, wherein the one or more processors are further configured to submit at least one image generated from the one or more surveillance sources to an emergency facility, the at least one image encoded to provide information relevant to an event requiring services of the emergency facility.
